(19) United States
(12) Patent Application Publication
(10) Pub. No.: US 2007/0109106 A1
(43) Pub. Date: May 17, 2007

(54) Driving information recording apparatus

(76) Inventors: Munenori Maeda, Kobe-shi (JP); Junichi Sawada, Kobe-shi (JP)

Correspondence Address: HARNESS, DICKEY & PIERCE, P.L.C., P.O. BOX 8910, RESTON, VA, 20195, US

(21) Appl. No.: 11/598,753

(22) Filed: Nov. 14, 2006

(30) Foreign Application Priority Data
Nov. 14, 2005 (JP) P2005-329526
Aug. 23, 2006 (JP) P2006-227173

(51) Int. Cl. B60R 25/10

(52) U.S. Cl. 340/426.1; 701/45; 280/735; 180/287

(57) ABSTRACT

There is provided a driving information recording apparatus having high versatility in which even in the event there is a request for an additional trigger, the requested trigger can be added in a simple fashion. When an ON/OFF port admits the input of a signal from an airbag ECU, a primary CPU conducts a control such that recording in a CF card is implemented using the signal inputted as a trigger. In particular, since the ON/OFF port is made to admit the input of a signal from another vehicle state detecting unit which is different from a detecting unit for detecting that a vehicle is put in a predetermined state, a drive recorder does not have to be re-fabricated from the beginning.

### BACKGROUND OF THE INVENTION

1. Field of the Invention

The present invention relates to a driving information recording apparatus and a technique for increasing its versatility or the like.

2. Description of the Related Art

Conventionally, a taxi dispatch system has been put to practical use in which a digital radio transmitter-receiver using a band of 400 MHz, for example, is adopted to increase the data communication volume so as to enhance the accuracy with which information on vehicles' positions and operation modes is collected. According to this taxi dispatch system, since the collection accuracy of information on vehicles' positions and the like is enhanced, the improvement in working efficiency of people in charge of dispatching taxies and taxi drivers can be attempted to be realized while attempting to satisfy demands from taxi users. Incidentally, a technique has been proposed in which a vehicle state is recorded endlessly, and once the vehicle is involved in an accident such as a collision, the endless recording is stopped and information that has been recorded until then is recorded in a separate recording medium (for example, refer to Japanese Unexamined Patent Publication JP-A 63-16785 (1988)).

In JP-A 63-16875 (1988), a trigger for a switch-over as described above is such as to be fixed at the time of production, and when a car manufacturer or a transportation company desires to analyze an accident or the like from a new point of view, an additional trigger needs to be added. Consequently, the drive recorder needs to be re-fabricated from the beginning, which causes very high costs.

### SUMMARY OF THE INVENTION

An object of the invention is to provide a driving information recording apparatus having high versatility in which even in the event that an additional trigger is requested, the request can be fulfilled in a simple fashion.

The invention provides a driving information recording apparatus comprising a unit for storing cyclically driving information on the driving of a vehicle in a memory unit and a unit for recording the driving information stored in the memory unit in a recording medium using as a trigger a signal that is inputted thereinto from a detecting unit for detecting that the vehicle is put in a predetermined state, the driving information recording apparatus including:

an input unit which is originally provided and into which a signal from a vehicle state detecting unit that is different from the detecting unit can be inputted; and

a control unit for conducting a control such that the driving information stored in the memory unit is recorded in the recording medium using as a trigger a signal inputted from the input unit.

According to the invention, when the signal is inputted from the vehicle state detecting unit into the input unit, the control unit conduct a control such that the driving information stored in the memory unit is recorded in the recording medium using the signal as the trigger for the operation. In particular, since a signal from the vehicle state detecting unit which is different from the detecting unit can be inputted into the input unit, there is no need to re-fabricate the drive recorder from the beginning, and cost which would otherwise have been incurred for re-fabrication can beat tempted to be reduced. Consequently, there can be provided the driving information recording apparatus which is highly versatile in adding an additional trigger in a simple fashion even in the event that such an additional trigger is requested.

Further, in the invention, it is preferable that a signal indicating a deployment of an airbag can be inputted into the input unit from an airbag control unit for having the airbag deployed when the vehicle is involved in a collision.

According to the invention, the airbag control unit is applied as the vehicle state detecting unit, and the control unit conducts a control such that the driving information is recorded in the recording medium using as a trigger the signal indicating a deployment of an airbag. The versatility of the driving information recording apparatus can be enhanced in this way.

Further, in the invention, it is preferable that in the control unit, a timing when to monitor whether or not there exists a signal indicating a deployment of an airbag can be set to occur earlier than a monitoring timing which is set originally.

According to the invention, since the timing when to monitor whether or not there exists a signal indicating a deployment of an airbag can be set to occur earlier than the monitoring timing which is set originally, the monitoring cycle of the trigger can be changed properly according to the contents of the trigger.

Further, in the invention, it is preferable that a signal raising an alarm can be inputted into the input unit from a security control unit for raising the alarm when detecting an attempt to steal the vehicle.

According to the invention, the driving information is recorded in the recording medium using as a trigger the signal raising the alarm from the security control unit for raising the alarm when detecting an attempt to steal the vehicle. The versatility of the driving information recording apparatus can be enhanced in this way.

Further, in the invention, the control unit monitors whether or not there exists a signal raising the alarm when the driving of the vehicle is stopped while ignoring the monitor of other unnecessary triggers when the driving of the vehicle is stopped.

According to the invention, since the control unit monitors whether or not there exists a signal raising the alarm when the driving of the vehicle is stopped while ignoring the monitor of other unnecessary triggers when the driving of the vehicle is stopped, the contents of a monitoring trigger can be limited according to the state of the vehicle. Consequently, the processing load of the control unit can be reduced.

Further, in the invention, it is preferable that the driving information recording apparatus is constituted so as to be started up by receiving a signal indicating an entry into a theft monitoring state, outputted from the security control unit,

wherein the control unit monitors whether or not there exists an alarm signal in the driving information recording apparatus running after being started up by the signal, and conducts a control such that the driving information stored in the memory unit is recorded using the alarm signal as a trigger.

According to the invention, the signal indicating the entry into the theft monitoring state is used to start up the driving information recording apparatus. In other words, the driving information recording apparatus can be started up by use of not an exclusive signal but an original theft monitoring signal. Accordingly, compared to a driving information recording apparatus using the exclusive signal, the driving information recording apparatus according to the invention can be provided with simplified wiring connections and the reduced number of components and manufacturing processes.

Further, in the invention, it is preferable that in a case where a signal indicating an entry into a theft monitoring state, outputted from the security control unit, is inputted into the driving information recording apparatus within a predetermined length of time after an accessory signal of the vehicle is brought into an OFF state,

the control unit keeps the driving information recording apparatus running, monitors whether or not there exists an alarm signal in the running state, and conducts a control such that the driving information stored in the memory unit is recorded using the alarm signal as a trigger.

According to the invention, in a case where the theft monitoring signal is inputted into the driving information recording apparatus within a predetermined length of time after the accessory signal is brought into the OFF state, the control unit keeps the driving information recording apparatus running and monitors the alarm signal in the running state. It is thus possible to keep the driving information recording apparatus running by using the original theft monitoring signal. Accordingly, the driving information recording apparatus can be provided with simplified wiring connections and the reduced number of components and manufacturing processes.

Further, in the invention, it is preferable that the control unit and the security control unit are adapted so as to be installable in an electrically connected state or non-connected state, the control unit having a function of determining whether or not being in the connected state,

wherein the control unit being in the connected state with the security control unit, after an accessory signal of the vehicle is brought into an OFF state, keeps the driving information recording apparatus running, monitors whether or not there exists an alarm signal in the running state, and conducts a control such that the driving information stored in the memory unit is recorded using the alarm signal as a trigger.

According to the invention, when the control unit and the security control unit are in the connected state, the driving information recording apparatus can be kept running after the accessory signal is brought into the OFF state. When there exists the alarm signal in the running state, the driving information stored in the memory unit is recorded.

Further, in the invention, it is preferable that the driving information recording apparatus further has a storage medium therein,

wherein the control unit controls such that the driving information stored in the memory unit using the alarm signal as a trigger is recorded in the storage medium disposed inside of the driving information recording apparatus without being recorded in the recording medium.

According to the invention, when there exists the alarm signal, the driving information is recorded in the storage medium disposed inside of the driving information recording apparatus without being recorded in the recording medium and therefore, a security level can be enhanced.

Further, in the invention, it is preferable that the control unit conducts a control such that the driving information stored in the storage medium is recorded in the recording medium by a predetermined operation.

According to the invention, the driving information stored in the storage medium can be recorded in the recording medium by a predetermined operation and therefore, the recording medium can be taken out to outside of the vehicle and thus subjected to analysis or the like. It is thus possible to enhance convenience.

Further, in the invention, it is preferable that the driving information recording apparatus further has a secondary battery therein, wherein the driving information recording apparatus is kept running by the secondary battery.

According to the invention, the driving information recording apparatus can be kept running by the secondary battery and therefore, even if a battery provided in the vehicle is drained, it is possible to record the driving information more reliably.

### BRIEF DESCRIPTION OF THE DRAWINGS

Other and further objects, features, and advantages of the invention will be more explicit from the following detailed description taken with reference to the drawings wherein:

FIG. 1 is a perspective view which shows a relationship between a drive recorder and a control unit according to a first embodiment of the invention;

FIG. 2 is a perspective view of a modified embodiment in which the drive recorder is partially modified;

FIG. 3 is a diagram which describes a mounting position where a camera is mounted on a vehicle;

FIGS. 4A and 4B are views illustrating a center, in which FIG. 4A is a drawing which shows the configuration of center equipment and FIG. 4B is a drawing which shows an output example in which a running locus of the vehicle, a photographed image and a measured value by a G sensor are outputted on a display;

FIG. 5 is a perspective view of the drive recorder;

FIG. 6 is a front view of the drive recorder;

FIG. 7 is a block diagram illustrating an electrical configuration of the control unit and the center;

FIG. 8 is a block diagram illustrating an electrical configuration of the drive recorder;

FIG. 9 is a block diagram illustrating an electrical configuration of the control unit;

FIG. 10 is a block diagram illustrating an electrical configuration of a main part of the control unit;

FIG. 11 is a block diagram illustrating an electrical configuration of a main part of the driver recorder;

FIG. 12 is a chart which explains a delay circuit which is reset by a hardware in the event that a watch dog pulse stops or is not operated at a regulated period;

FIG. 13 is a block diagram illustrating an electrical configuration of a main part of the drive recorder of a modified embodiment, which is partially modified;

FIG. 14 is a diagram illustrating a relationship between part of image information and position information or the like;

FIG. 15 is a chart illustrating how stationary image information is recorded in the CF card at a constant interval δ based on a G sensor output value;

FIG. 16 is a chart illustrating a relationship between a G sensor output value which exceeds a threshold value and a recording range Rh of image information that is recorded in the CF card;

FIG. 17 is a graph which describes a threshold value determination method for the G sensor output value;

FIG. 18 is a chart illustrating a relationship between an ON signal S3 of the photographing switch and a recording range Rh of image information that is recorded in the CF card;

FIG. 19 is a chart which describes a relationship between a photographing request command reception through communication and a recording range Rh of image information that is recorded in the CF card;

FIG. 20 is a chart which describes how to regulate a recording range for speech information that is recorded in the CF card based on a Hi/Lo signal S4 from the vehicle's occupied/vacant status indicating meter;

FIG. 21 is a chart illustrating how image information is recorded from before to after a point in time when a Hi signal is outputted from the vehicle's occupied/vacant status indicating meter and how image information is recorded from before to after a point in time when a Lo signal is outputted from the vehicle's occupied/vacant status indicating meter;

FIG. 22 is a block diagram which describes various ways of taking in triggers in the drive recorder;

FIG. 23 is a graph showing how warning information is sent out based on a threshold value of the operation data;

FIG. 24 is a graph showing a relationship between G sensor output value and detection time;

FIG. 25 is a chart showing tendencies based on a relationship between the magnitude of G sensor output value and detection time thereof;

FIG. 26 is a flowchart illustrating a basic operation by the G sensor and external switch detection;

FIG. 27 is a graph showing a relationship between a threshold value of the G sensor output value and determination time thereof;

FIG. 28 is a timing chart showing a relationship between Hi/Lo signals and determination time thereof;

FIGS. 29A and 29B are flowcharts illustrating processes for recording speed data, in which FIG. 29A is a flowchart illustrating a process for recording speech data from before to after a change in vehicle's occupied/vacant status, and FIG. 29B is a flowchart illustrating a process for recording speech data while the vehicle is being occupied;

FIG. 30 is a flowchart illustrating a first process for outputting a synthetic speech by the control unit;

FIG. 31 is a flowchart illustrating a second process for outputting a synthetic speech by the control unit;

FIG. 32 is a block diagram showing an electrical configuration of the drive recorder in which a serial port of other equipment and other components are incorporated;

FIG. 33 is a block diagram showing a connection example with an airbag ECU;

FIGS. 34A and 34B show a process for changing the trigger monitoring cycle or the like, in which FIG. 34A is a flowchart, and FIG. 34B is a map showing trigger cycles corresponding to various triggers;

FIG. 35 is a flowchart illustrating a process for recording on the CF card image and speech which result when an airbag is activated;

FIG. 36 is a block diagram showing a connection example (1) with a security ECU;

FIG. 37 is a flowchart illustrating a process for monitoring an external input SW only;

FIG. 38 is a block diagram illustrating a connection example with a plurality of pieces of equipment;

FIG. 39 is a block diagram showing a connection example (2) between the security ECU and the drive recorder according to an embodiment of the invention;

FIG. 40 is a flowchart illustrating a process for recording an image and so forth on a primary ROM based on a lock signal or the like;

FIGS. 41A and 41B show timing charts, in which FIG. 41A is a timing chart illustrating a mode that a primary CPU has determined presence of the lock signal it an OFF state of a power supply control signal S2 after T1 seconds elapsed after an ACC signal is brought into an OFF state (PL1), and FIG. 41B is a timing chart illustrating a mode that the primary CPU has determined presence of the lock signal before T1 seconds elapsed after the ACC signal is brought into the OFF state (PL1);

FIG. 42 is a block diagram showing a connection example (3) between the security ECU and the drive recorder according to an embodiment of the invention;

FIG. 43 is a block diagram showing a connection example (4) between the security ECU and the drive recorder according to an embodiment of the invention; and

FIG. 44 is a flowchart illustrating a process for recording an image and so forth on the primary ROM based on an operation of a setting switch.

### DETAILED DESCRIPTION

Now referring to the drawings, preferred embodiments of the invention are described below.

A mode for carrying out the invention will be described by reference to the accompanying drawings by taking a plurality of embodiments as examples. In descriptions of each embodiment, there may occur a case where like reference numerals are imparted to those which correspond to matters which have already been described in a preceding embodiment, so as to omit the repetition of a similar description. In a case where only part of a configuration is described, the other parts of the configuration are understood to be similar to those of the preceding embodiment that has already been described. Not only a combination of parts that are described specifically in each embodiment but also a combination of parts of the embodiments is possible, provided that no specific problem is caused by such a combination.

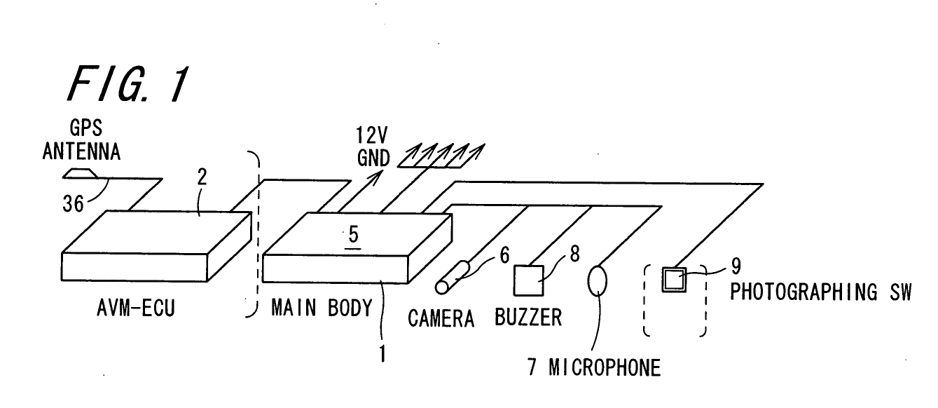

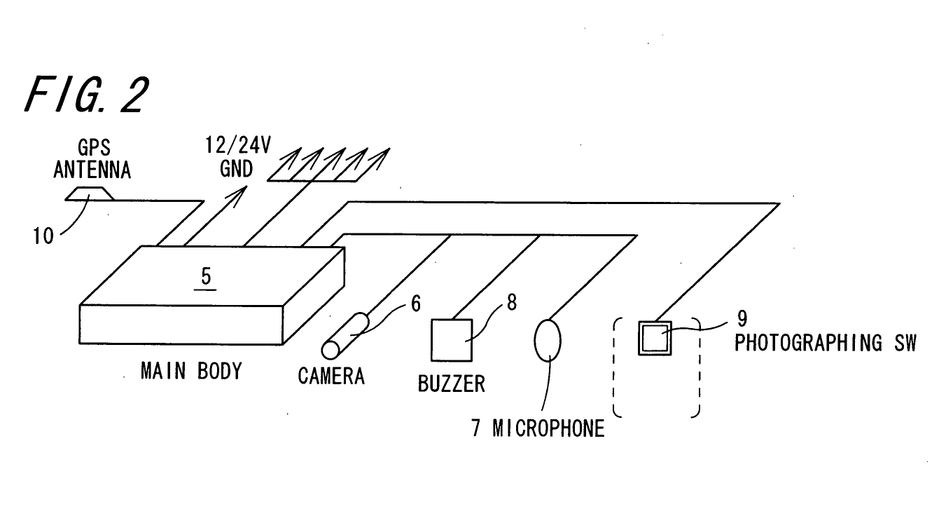

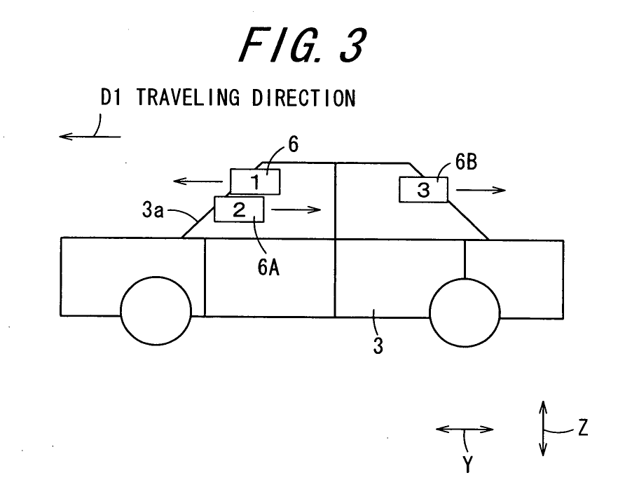

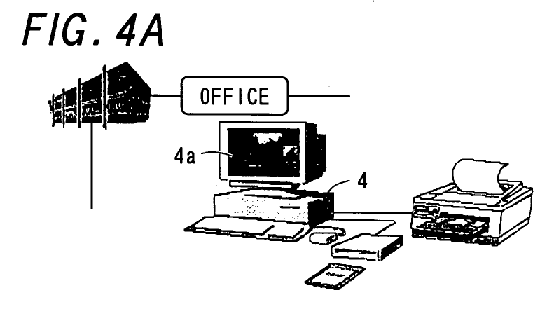

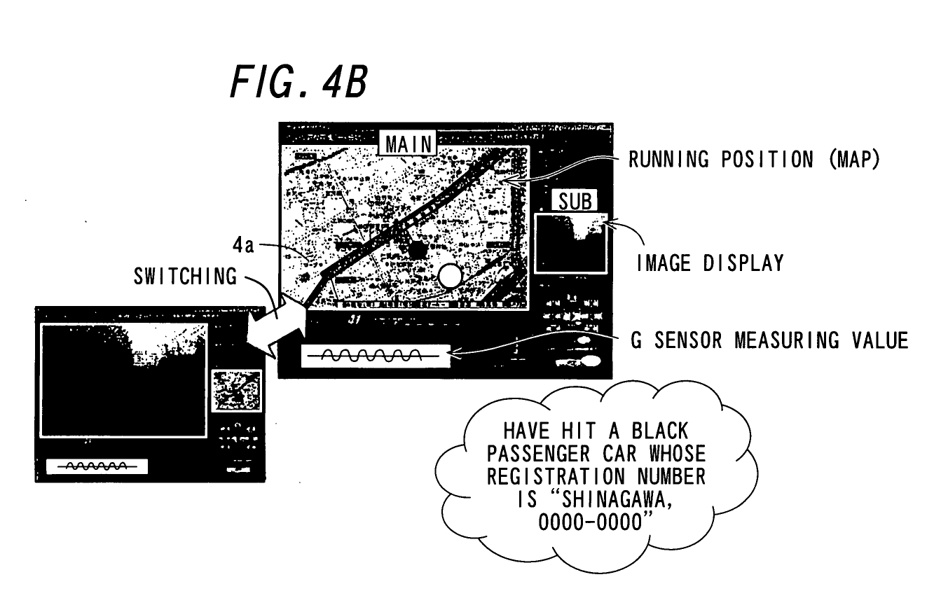

FIG. 1 is a perspective view which shows a relationship between a drive recorder 1 and a control unit 2 according to a first embodiment of the invention. FIG. 2 is a perspective view of a modified embodiment in which the drive recorder 1 is partially modified. FIG. 3 is a diagram which describes a mounting position where a camera is mounted on a vehicle 3. FIGS. 4A and 4B are views illustrating a center 4, in which FIG. 4A is a drawing which shows the configuration of center equipment and FIG. 4B is a drawing which shows an output example in which a running locus of the vehicle 3, a photographed image and a measured value by a G sensor are outputted on a display 4a. In the first embodiment, the drive recorder 1 is provided in such a manner as to be electrically connected to an operation managing control unit 2 (occasionally, referred to as AVM-ECU2) which is originally installed on the vehicle 3. Information on the position, time and operation mode of the vehicle 3 can be transmitted from the control unit 2 to the center 4 by using a digital radio frequency in a band of, for example, 400 MHz, and the center 4 instructs a specific one of a plurality of vehicles 3 to be dispatched based on the information. In addition, the center 4 requests the drive recorder 1 to take a photograph via the control unit 2 using the radio frequency. However, the applied radio frequency is not necessarily limited to the band of 400 MHz. For example, a frequency band can be applied which is allocated to mobile telephones. There can be a case where not the digital radio frequency but an analog radio frequency is applied to the radio frequency used.

The drive recorder 1 which is the driving information recording apparatus according the first embodiment, is designed not only to record information on the position, time and operation mode of the vehicle 3 (referred to as information or the like) which are sent from the control unit 2 but also to record an image and speech information in relation to the information or the like in the event that a predetermined condition is met. The center equipment is configured so as to analyze and output these pieces of information recorded in the drive recorder 1.

The drive recorder 1 has a drive recorder main body 5, a camera 6, a microphone 7 for acquiring speech information inside a passenger compartment and a buzzer 8 for sending warning information. The camera 6 and the microphone 7 are provided separately from the drive recorder main body 5 in such a manner as to be electrically connected thereto, and the buzzer 8 is provided integrally with the drive recorder main body 5. At least one camera 6 is provided on the vehicle 3. The camera 6 is made up of a CCD camera (CCD: Charge Coupled Device). This camera 6 is affixed to, for example, a position on a windscreen 3a which corresponds to the back of an inside rearview mirror via a bracket, not shown, so as to photograph a forward direction of the vehicle as indicated by an arrow D1 in FIG. 3. Namely, this camera 6 is fixed in place in such a manner as to be directed towards the front of the vehicle. In the drive recorder 1, a second or a third camera 6 can be provided on the vehicle 3, and specifically speaking, a photographing camera 6A within a passenger compartment of the vehicle 3 or a photographing camera 6B for photographing the rear view behind the vehicle. There may also occur a case where a photographing switch 9 for activating these cameras 6 is provided separately from the drive recorder main body 5 in such a manner as to be electrically connected thereto.

In addition, as shown in FIG. 2, a driver recorder 1A can be applied to the vehicle in which a GPS (Global Positioning System) antenna 10, a GPS receiver, not shown, and the like are added to the drive recorder main body 5.

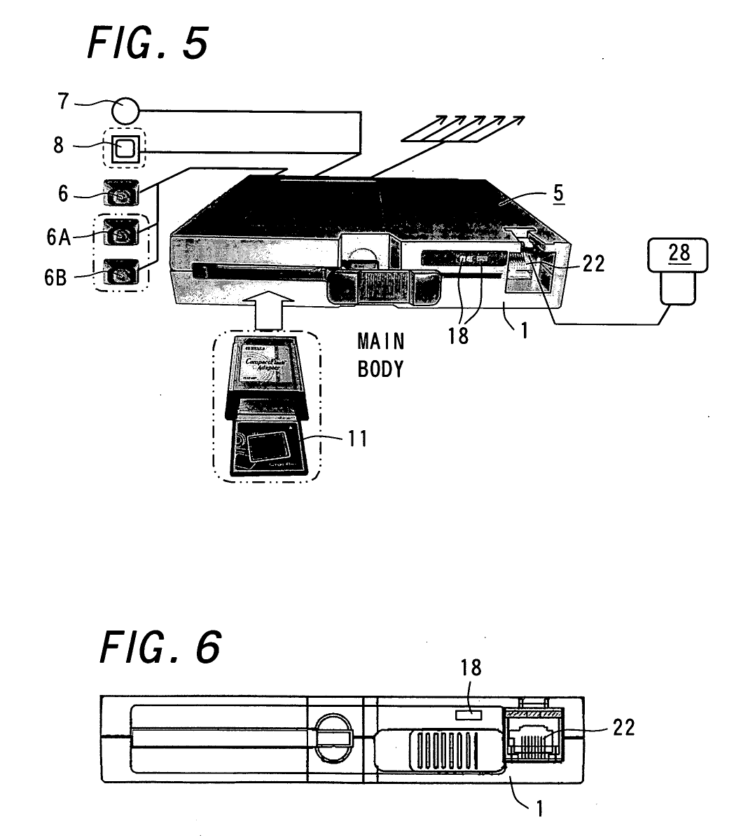

FIG. 5 is a perspective view of the drive recorder 1, and FIG. 6 is a front view of the drive recorder 1. The drive recorder main body 5 is configured to receive therein a CF card 11 (CF: Compact Flash) which is designed to be inserted into and removed from the drive recorder main body 5. This CF card 11 has a construction where a flash memory which does not lose its memory even in case it is not energized and a controller circuit which is responsible for input from and output to an external apparatus are integrated into a single card. Driving information including images on the periphery of the vehicle, speech information from the microphone inside the passenger compartment, position, individual, time and vehicle's occupied/vacant status information is recorded sequentially and endlessly in a primary RAM12 (RAM: Random Access Memory), which will be described later on, of the drive recorder main body 5. At least part of the information is recorded in the CF card in the event that a predetermined condition is met. In particular, in the case of a trigger for determination of an occupied/vacant vehicle, only speech and vehicle's occupied/vacant status information of the plurality of pieces of driving information are designed to be recorded in the CF card 11.

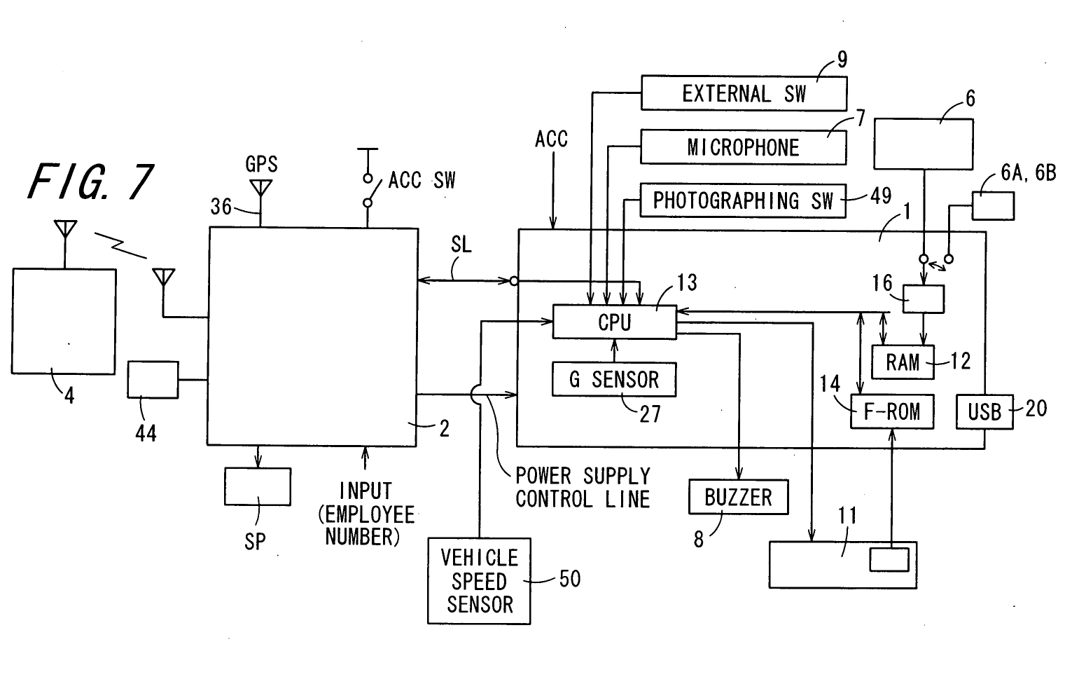

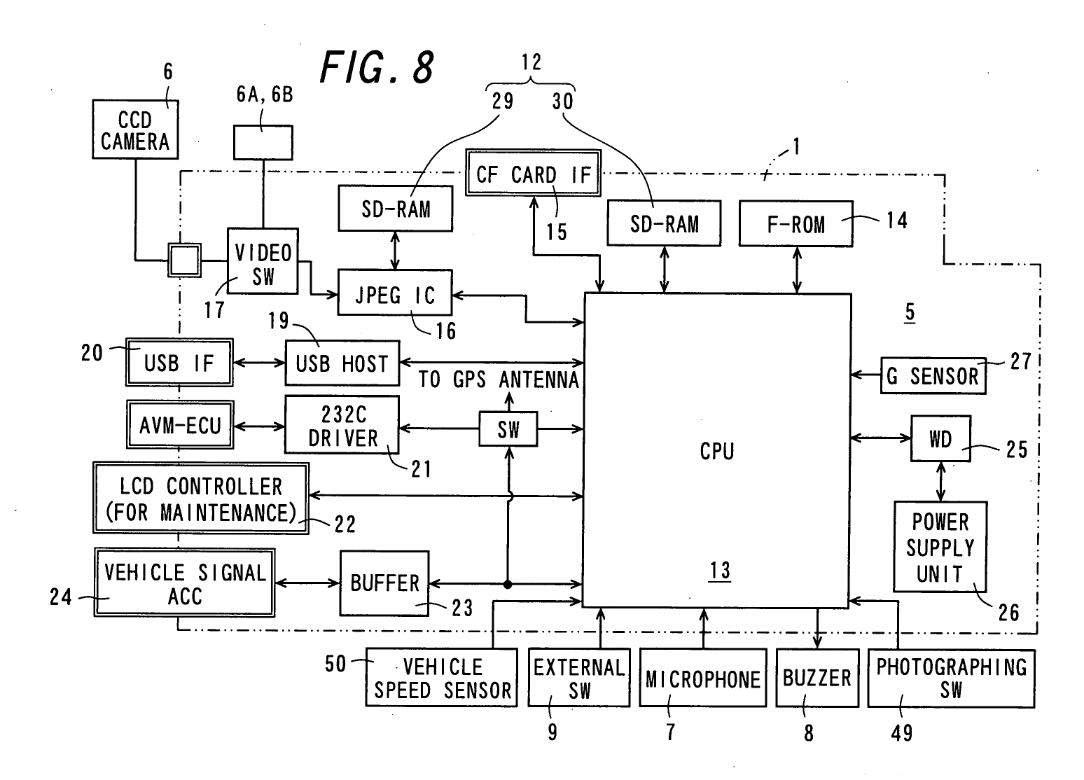

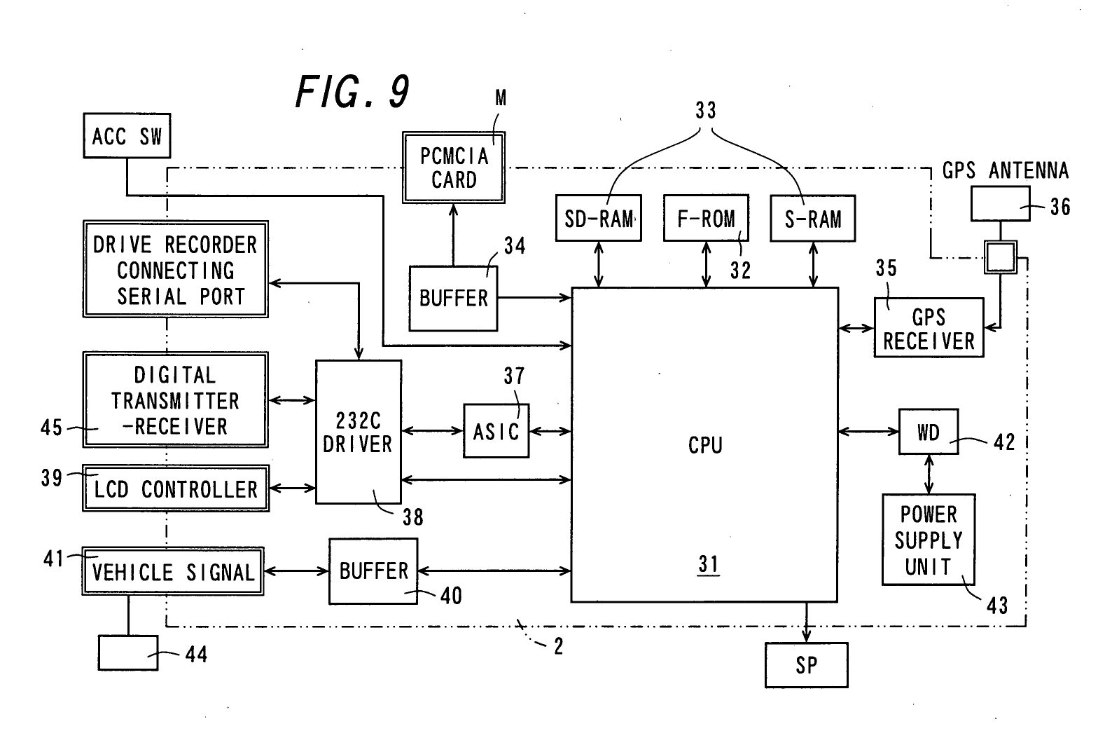

FIG. 7 is a block diagram illustrating an electrical configuration of the control unit 2 and the center 4. FIG. 8 is a block diagram illustrating an electrical configuration of the drive recorder 1. FIG. 9 is a block diagram illustrating an electrical configuration of the control unit 2. The drive recorder main body 5 has a primary CPU 13 (CPU: Central Processing unit) as a control unit, a primary ROM 14 (ROM: Read Only Memory), the primary RAM12 as the memory unit, a CF card interface 15, JPEG IC 16 (JPEG: Joint Photographic Coding Experts Group, IC: Integrated Circuit), a video switch 17 and a light emitting diode 18 (referred to as an LED, refer to FIG. 5). The drive recorder main body 5 has a USB HOST 19 (USB: Universal Serial Bus) which is a unit having a USB host function, a USB interface 20, a primary communication driver 21 which exchanges information between the control unit 2 and itself, an LCD controller connector 22 (LCD: Liquid Crystal Display), a primary buffer 23, a primary circuit 24 which detects a power supply start-up signal from the control unit 2, a primary watch dog IC 25 having a watch dog function, a primary power supply unit 26, a G sensor 27 and a counter, not which, which accumulates vehicle speed pulses. An LCD controller 28 for a maintenance mode, which will be described later on, is configured so as to be connected to the LCD controller connector 22. The G sensor 27 is a sensor for detecting a gravitational acceleration which is applied in longitudinal and transverse directions of the vehicle 3 or a G sensor output value. Note that forward and rearward directions and leftward and rightward directions of an occupant seated in a driver's seat of the vehicle 3 are the longitudinal direction and the transverse direction, respectively. A direction which intersects the longitudinal and transverse directions at right angles is regarded as a vertical direction. The longitudinal direction is defined as a Y-axis direction, and the transverse direction is defined as an X-axis direction. A G sensor output value in the X-axis direction and a G sensor output value in the Y-axis direction are detected and recorded independently.

The primary RAM 12 includes a primary SD-RAM (Synchronous DRAM) 29 and a secondary SD-RAM 30, and the primary SD-RAM 29 is such as to record temporarily a raw image photographed by the camera, and an image so recorded is converted into an imaged at a of JPEG system. The secondary SD-RAM 30 is configured so as to record endlessly and cyclically the image data converted into the JPEG system, a G sensor output value from the G sensor 27 and speech. The primary ROM14, the secondary SD-RAM 30 and the CF card interface 15 are electrically connected to the primary CPU 13, and the primary SD-RAM 29 and the video switch 17 are electrically connected to the primary CPU 13 via the JPEG IC 16. The video switch 17 is a switching switch for switching a plurality of cameras 6, 6A(6B) at an interval of a predetermined period of time, in the event that the plurality of cameras 6, 6A(6B) are provided. A USB interface 20 is connected to the primary CPU13 via a HOST 19, and the communication driver 21, the LCD controller connector 22, the primary buffer 23, the primary watch dog IC 25 and the G sensor 27 are electrically connected to the primary CPU 13. The primary buffer 23 is electrically connected to the primary circuit 24. The primary power supply unit 26 is electrically connected to the primary watch dog IC 25. In addition, the primary CPU 13 is configured so as to start up the primary power supply unit 26, which is a main power supply, based on power supply ON information from the control unit 2. Additionally, in the event that no power supply start-up signal is obtained from the control unit 2, understanding that the power supply unit 26 is not connected to the control unit 2, the user switches an input from the communication driver 21 to an input that is to be inputted to the GPS antenna side by a switch, whereby a position based on position information from the GPS can be detected singly instead of using position information from the control unit 2.

The control unit 2 has a microcomputer which includes a secondary CPU 31 for AVM, a secondary ROM 32 and a secondary RAM 33, a secondary buffer 34, a GPS receiver 35, a GPS antenna 36, an AIIC (Application Specific Integrated Circuit) 37, a secondary communication driver 38, an LCD controller 39, a tertiary buffer 40, a secondary circuit 41 for detecting a Hi/Lo signal from the vehicle 3, a secondary watch dog IC 42 and a secondary power supply unit 43. The secondary ROM 32 and the secondary RAM 33 are electrically connected to the secondary CPU 31, and a card M, which complies with the PCMCIA standard, is also electrically connected to the secondary CPU 31 via the secondary buffer 40. The secondary communication driver 38 is electrically connected to the secondary CPU 31 via the ASIC 37, and a digital radio transmitter-receiver 45, which can implement transmission and reception at a digital radio frequency in a band of 400 MHz, is electrically connected to the secondary communication driver 38. Incidentally, in the first embodiment, while the GPS receiver 35 and the GPS antenna 36 are configured so as to be provided in the control unit 2, it is also possible to configure, as shown in FIG. 2, such that the GPS receiver and the GPS antenna 10 are provided in the drive recorder main body 5.

It is configured such that position information and time information are acquired using the GPS antenna 36 and the GPS receiver 35, while taxi driver data can be inputted from the LCD controller 39. Vehicle's occupied/vacant status information is acquired from a vehicle's occupied/vacant status indicator meter 44 which is operated by the driver. A switch which is operated by the driver is provided on the vehicle's occupied/vacant status indicator meter 44. The switch is operated to be switched to an occupied state indicating side by the driver when he or she conforms a destination with a passenger who enters the passenger compartment of the taxi. When the taxi arrives at the destination, the switch is operated to be switched to a vacant state indicating side by the taxi driver, and then, a fare to be paid by the passenger is determined.

The position information and time information, the taxi driver data and the vehicle's occupied/vacant status information are stored in the secondary ram 33 temporarily. When a request for transmission of information is made by the center 4 via the digital radio transmitter-receiver 45, the information so stored in the secondary RAM 33 is sent out to the center 4 via the digital radio transmitter-receiver. Alternatively, the control unit 2 may be configured to transmit the information to the center 4 voluntarily. Furthermore, when a vehicle dispatch request from the center 4 is received by the digital radio transmitter-receiver 45, the request is transferred to the driver via a speaker SP.

Since the control unit 2 originally has the basic function like this, the control unit 2 send out acquired position information and time information, taxi driver data, and vehicle's occupied/vacant status information to the drive recorder 1 via the driver 38 through a serial communication line SL. The drive recorder 1 receives the information via the primary communication driver 21 and stored the information so received in the secondary SD-RAM 30.

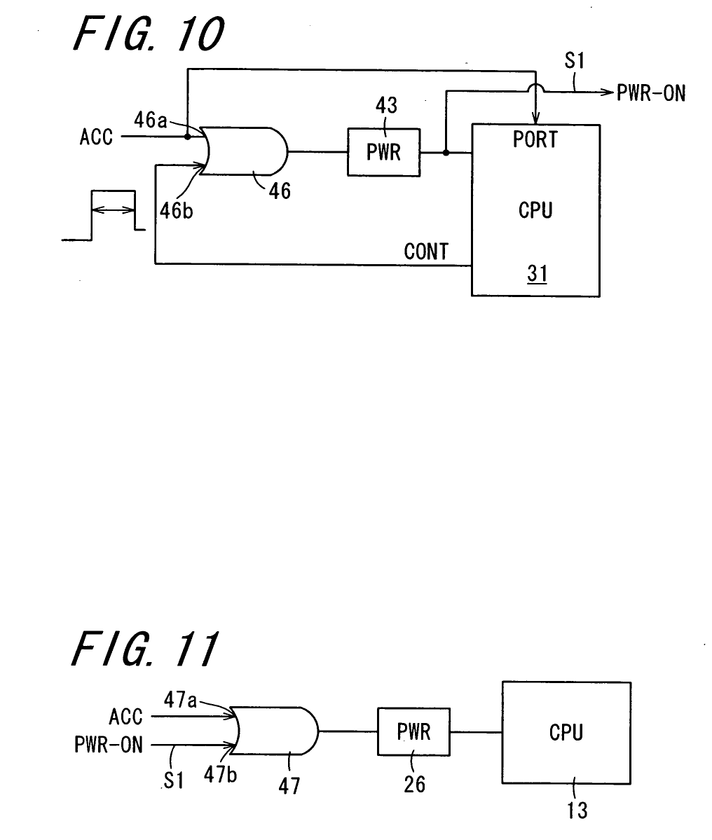

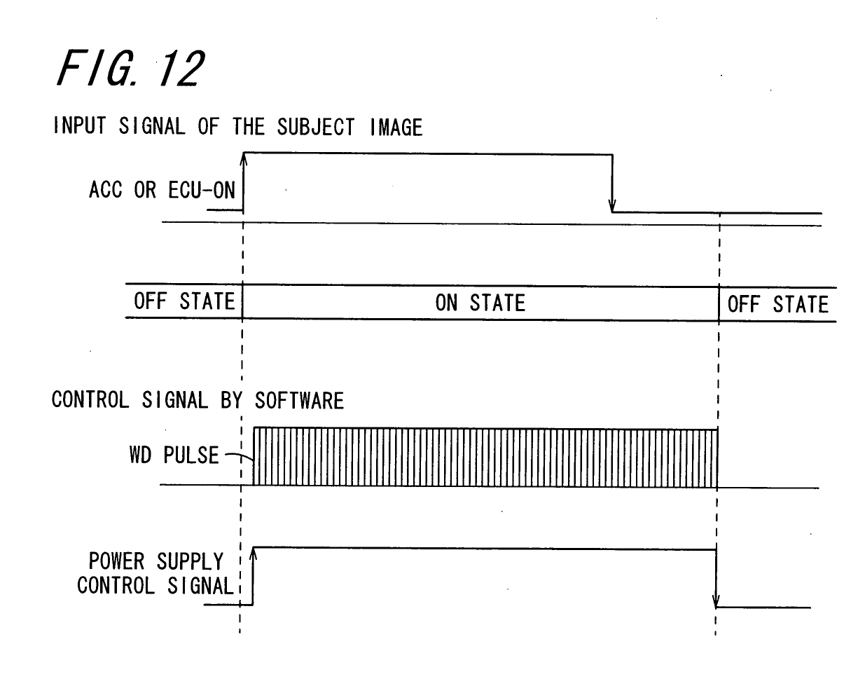

FIG. 10 is a block diagram illustrating an electrical configuration of a main part of the control unit 2. FIG. 11 is a block diagram illustrating an electrical configuration of a main part of the driver recorder 1. FIG. 12 is a chart which explains a delay circuit which is reset by a hardware in the event that a watch dog pulse stops or is not operated at a regulated period. As shown in FIG. 10, in the control unit 2, an accessory power supply of the vehicle 3 is connected to one 46a of inputs of an exclusive circuit 46 or an OR circuit 46, and a control signal is supplied to the other input 46b of the OR circuit 46 from the secondary CPU 31. A power supply ON signal S1 is supplied to the drive recorder 1 side from the secondary power supply unit 43 which is connected between the OR circuit 46 and the secondary CPU 31. Namely, as shown in FIG. 11, in the drive recorder 1, the accessory power supply is connected to one 47a of inputs of an OR circuit 47, and the power supply ON signal S1 is supplied to the other input 47b of the inputs of the OR circuit 47.

The drive recorder 1 is started up when the ACC signal supplied from the accessory power supply is ON or the power supply of the control unit 2 is ON. In addition, the drive recorder 1 is designed such that the recorder is controlled to be terminated by a software in such a manner as to execute a data recording even in the event that the ACC signal is OFF and the secondary power supply unit 43 of the control unit 2 becomes OFF (a fall signal in FIG. 12). As shown in FIG. 12, a watch dog pulse (described as WD pulse in FIG. 12) is generated by a soft ware while the control unit 2 is in operation, and in the event that the watch dog pulse so generated stops or does not operate at a regulated period, the control unit 2 is designed to be reset by a hardware. In this embodiment, the secondary watch dog IC 42 and the secondary CPU 31 correspond to the delay circuit.

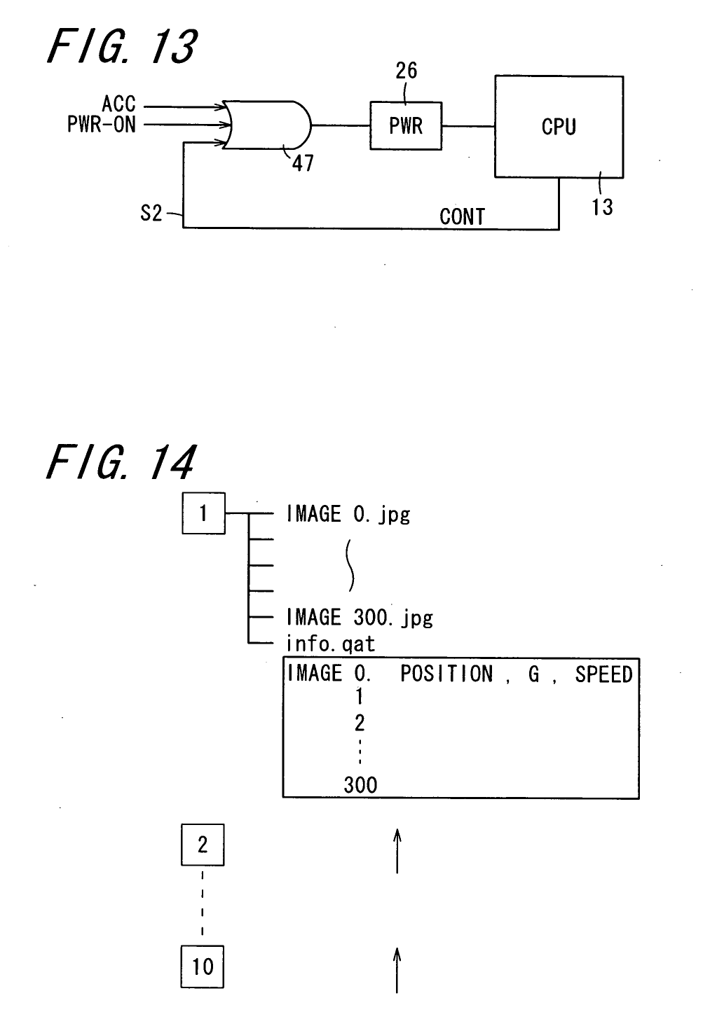

FIG. 13 is a block diagram illustrating an electrical configuration of a main part of the drive recorder 1 of a modified embodiment, which is partially modified. In this embodiment, while in the drive recorder 1, the ACC signal and the power supply ON signal S1 are made to be supplied to the input side of the OR circuit 47, the invention is not necessarily limited to such a form. Namely, as shown in FIG. 13, a form may be adopted in which the ACC signal, the power supply ON signal and a control signal S2 from the primary CPU 13 are supplied to the input side of the OR circuit 47 in the driver recorder 1. Even in this modified form, a watch dog pulse is generated by a software while the drive recorder 1 is in operation, and in the event that the watch dog pulse so generated stops or is not operated at a regulated period, the drive recorder 1 can be reset by the hardware. In the modified form, the primary watch dog IC 25 and the primary CPU 13 correspond to the delay circuit.

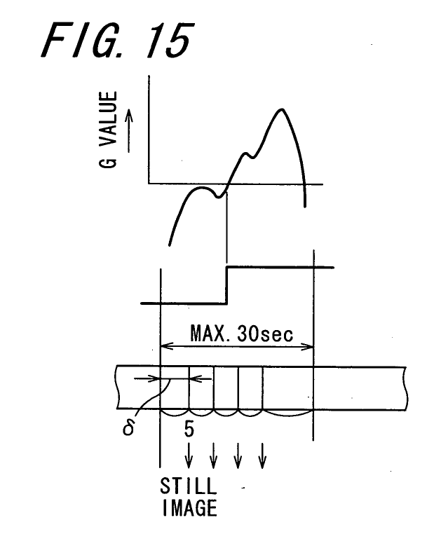

FIG. 14 is a diagram illustrating a relationship between part of image information and position information or the like. FIG. 15 is a chart illustrating how stationary image information is recorded in the CF card 11 at a constant interval 6 based on a G sensor output value. The primary CPU 13 has an input image photographed by the camera 6 to be inputted into the drive recorder main body 5 converted into a JPEG converted image by the JPEG IC 16, and thereafter, the primary CPU 13 records endlessly the JPEG converted image in the secondary SD-RAM 30. As this occurs, a stationary image is recorded in, for example, a format of “image*.jpg.” However, the symbol “*” is an integer. As added information to the recorded stationary image, the G sensor output value, position, time and occupied/vacant status information of the vehicle 3, vehicle speed information from a vehicle speed sensor 50 and speech information from the microphone 7 are recorded sequentially in the secondary SD-RAM 30.

In the event that a predetermined recording condition is met, the primary CPU 13 makes the buzzer 8 output a signal to start recording. In association with this, the primary CPU 13 has the JPEG converted image, GPS output value, position, time, vehicle's occupied/vacant status information and vehicle speed information from the vehicle speed sensor 50, which are recorded in the secondary SD-RAM 30, recorded in the CF card 11. In this embodiment, ten stationary images are recorded in one second, for example, and a maximum of 300 stationary images over 30 seconds for one event can be recorded in the CF card 11. In meaning, one event is identical to one state in which a predetermined recording condition is met.

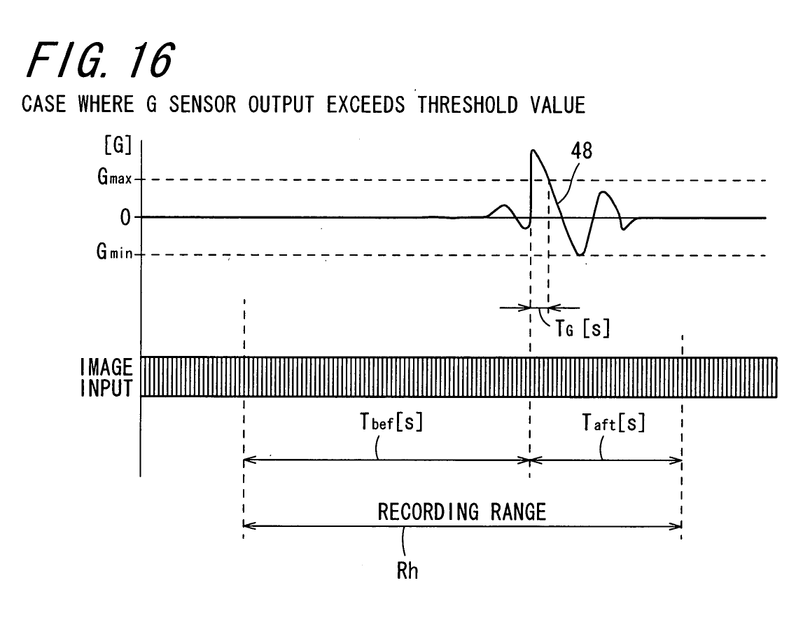

The recording condition or the like will be described. FIG. 16 is a chart illustrating a relationship between a G sensor output value 48 which exceeds a threshold value and a recording range Rh of image information that is recorded in the CF card 11. As the recording condition, when the G sensor output value 48 exceeds a threshold value Gmax. or Gmin., the JPEG converted image, G sensor output value thereof, position, time, vehicle's occupied/vacant status and vehicle speed information, speech information from the microphone 7, which are recorded endlessly in the secondary SD-RAM are recorded in the CF card 11 over the maximum recording range of 30 seconds based on the threshold value exceeding point. There may occur a case where the threshold value exceeding point is referred to as a trigger generation point. A time resulting when a recording time of T_{aft} seconds after the trigger generation is added to a recording time of T_{bef} seconds before the trigger generation corresponds to a total time of a recording range for one event. A maximum of 30 seconds can be set in a range from 5 seconds or more but 25 seconds or less before the trigger generation to 5 seconds or more but 25 seconds or less after the trigger generation.

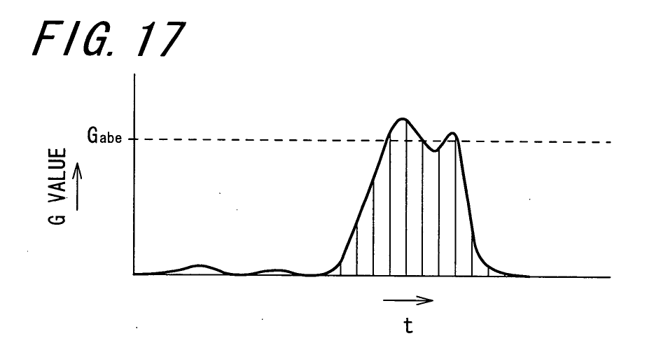

FIG. 17 is a graph which describes a threshold value determination method for the G sensor output value. FIGS. 7 and 8 will also be referred to during the description. The primary CPU 13 acquires an output of the G sensor and determines whether or not the value so acquired exceeds a threshold value G_{abc}. As has been described before, the G sensor 27 is of the biaxial type in the X- and Y-axis directions and is made to detect a gravitational acceleration in the longitudinal direction and the transverse direction of the vehicle 3. Consequently, the G sensor 27 can detect not only a collision accident in the longitudinal direction but also a collision accident in the transverse direction in an ensured fashion in such a manner as to analyze for a cause thereof. A threshold determination is implemented by a vector sum of a longitudinal gravitational acceleration and a transverse gravitational acceleration. This threshold value is made to be altered to an arbitrary value through setting.

In this embodiment, since a situation can be considered to occur in which the drive recorder main body 5 which incorporates therein the G sensor 27 cannot be set completely horizontally, a process is designed to be implemented to correct longitudinal and transverse offset of the G sensor 27. Namely, as shown in FIG. 5, when the LCD controller 28 is connected to the LCD controller connector 22, the drive recorder main body 5 is shifted from a normal mode to a maintenance mode where the drive recorder main body 5 is set and inspected. In this maintenance mode, the process to correct the longitudinal and transverse offset of the G sensor 27 is designed to be executed. When the vehicle 3 is driven on a rough road, vertical vibrations become large undesirably, the G sensor 27 is expected to detect not only a longitudinal gravitational acceleration but also a transverse gravitational acceleration. Consequently, vertical vibrations are designed to be monitored while the vehicle 3 is driven on a rough road, so as to apply a process to reduce a reaction error to a G sensor output value.

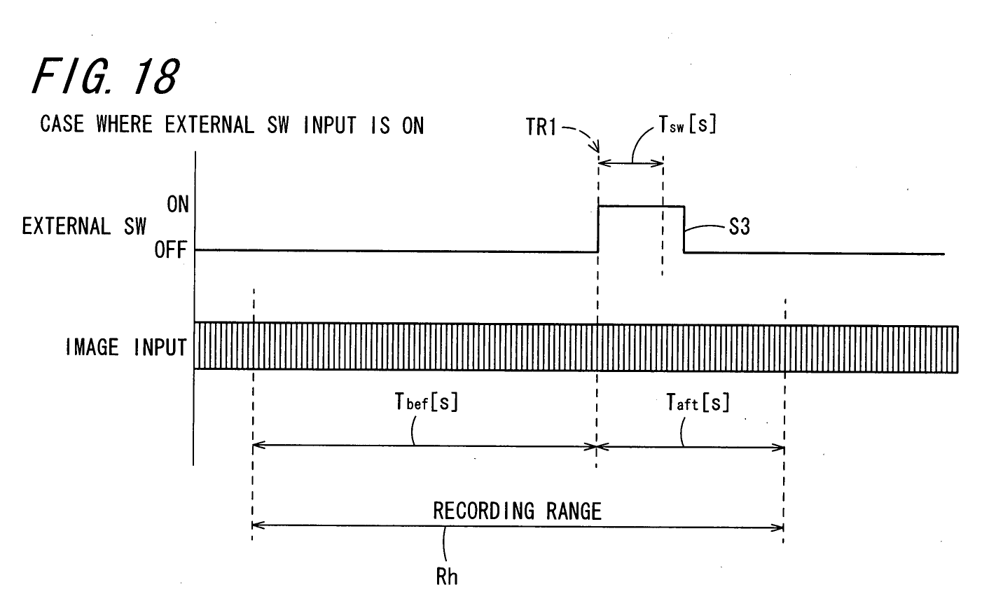

FIG. 18 is a chart illustrating a relationship between an ON signal S3 of the photographing switch 9 and a recording range Rh of image information that is recorded in the CF card 11. As the recording condition, when the taxi driver switches on the photographing switch 9 so as to switch switching modes thereof, the JPEG converted image that has been recorded in the secondary SD-RAM 30 endlessly, a G sensor output value, position, time, vehicle's occupied/vacant status and vehicle speed information and speech information from the microphone 7 which resulted when the photographing switch 9 was switched on are recorded in the CF card 11 over the maximum recording range of 30 seconds based on a photographing switch ON point TR1 (referred to as a trigger generation point). A time resulting when a recording time of T_{aft} seconds after the trigger generation is added to a recording time of T_{bcf} seconds before the trigger generation, i.e., T_{bcf}+T_{aft} seconds, corresponds to a total time of a recording range for one event. However, when the JPEG converted image or the like is recorded in the CF card 11 using the photographing switch 9 as the trigger, the drive recorder main body 5 can be set such that with the number of times of operating the photographing switch 9 limited, when the number of times of operating the photographing switch 9 reaches a predetermined number of times of operation, no further recording on the CF card 11 is implemented thereafter even in the event that the photographing switch 9 is operated.

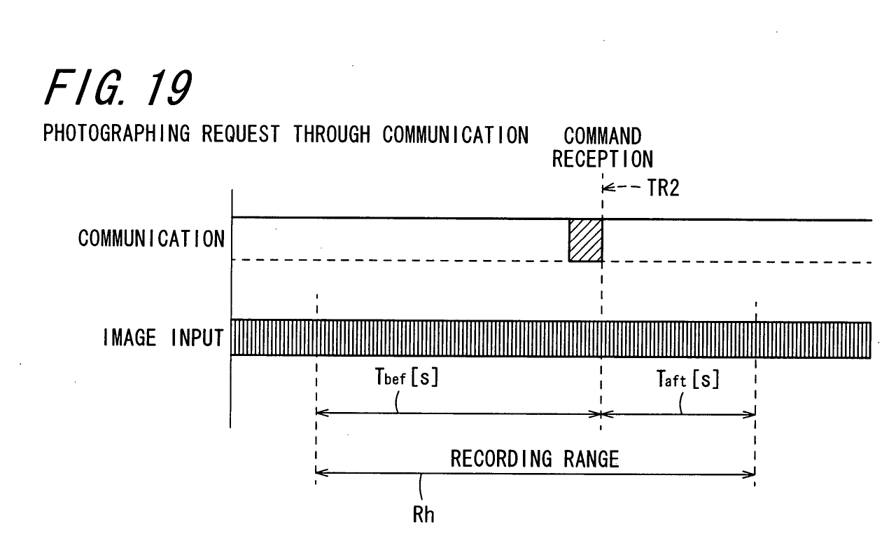

FIG. 19 is a chart which describes a relationship between a photographing request command reception through communication and a recording range Rh of image information that is recorded in the CF card 11. FIG. 7 will also be referred to during the description. As the recording condition, an image photographing request is sent from the center 4 to the control unit 2 by a radio frequency, the primary CPU 13 of the drive recorder main body 5 receives the signal as a command. Then, the JPEG converted image that has been recorded in the secondary SD-RAM 30 endlessly, a G sensor output value, position, time, vehicle's occupied/vacant status and vehicle speed information and speech information from the microphone 7 which resulted when the command was received are recorded in the CF card 11 over the maximum recording range of 30 seconds based on a command reception point TR2 (referred to as a trigger generation point). A time resulting when a recording time of T_{aft} seconds after the trigger generation is added to a recording time of T_{bef} seconds before the trigger generation, i.e., T_{bef}+T_{aft} seconds, corresponds to a total time of a recording range for one event. When the center 4 determines that the speed of the vehicle 3 which is obtained based on a vehicle speed pulse which is one of operation data becomes larger than a predetermined regulated speed, the image recording request from the center 4 is executed. Note that a parameter attributed to the trigger generation is not limited to the vehicle speed pulse. There may occur a case where the image recording request from the center 4 is executed based on at least any of operation data such as periodic recording, sudden acceleration, sudden braking and abrupt steering. By using the plurality of operation data, a detailed driving guidance can be carried out for individual taxi drivers at the center 4.

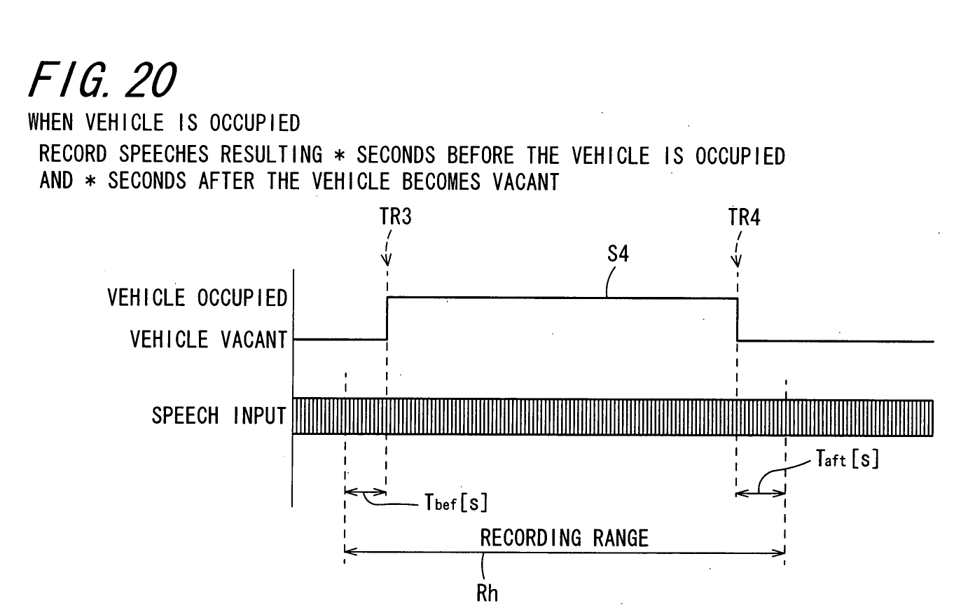

FIG. 20 is a chart which describes how to regulate a recording range for speech information that is recorded in the CF card 11 based on a Hi/Lo signal S4 from the vehicle's occupied/vacant status indicating meter 44. As a recording condition for speech information, when a Hi signal is outputted which switches the status of the vehicle from a vacant state to an occupied state, the speech information recorded in the secondary SD-RAM 30, the vehicle's occupied/vacant status and vehicle speed information are started to be recorded in the CF card 11 T_{bef} seconds (T_{bef} seconds is, for example, several tens of seconds) before a point in time when the Hi signal is outputted. When a Lo signal is outputted which switches the status of the vehicle from the occupied state to the vacant state in this recording state, speech information or the like continues to be recorded in the CF card 11 until a point in time which results when T_{aft} seconds (T_{aft} seconds is, for example, several tens of seconds) has elapsed since a point in time TR4 when the Lo signal is outputted. Since the control unit 2 detects the signal from the vehicle's occupied/vacant status indicating meter 44, the drive recorder 1 can detect the vehicle's occupied/vacant status through a serial communication with the control unit 2. In the event that there is no link with the control unit 2, an ON/OFF signal of the vehicle's occupied/vacant status indicating meter 44 may only have to be taken in as an external switch of the drive recorder 1.

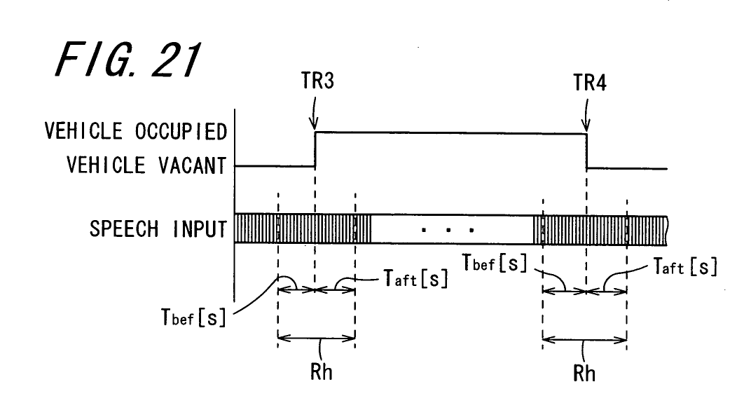

FIG. 21 is a chart illustrating how image information is recorded from before to after a point in time when a Hi signal is outputted from the vehicle's occupied/vacant status indicating meter 44 and how image information is recorded from before to after a point in time when a Lo signal is outputted from the vehicle's occupied/vacant status indicating meter 44. As a recording condition, when a Hi signal is outputted which switches the status of the vehicle from a vacant state to an occupied state, speech information and vehicle's occupied/vacant status information of the information that is recorded in the secondary SD-RAM 30 endlessly are recorded in the CF card 11 for a maximum recording range of 30 seconds based on a point in time TR3 when the Hi signal is outputted (referred to as a first trigger generation point). A time Rh resulting when a recording time of T_{aft} seconds after the first trigger generation is added to a recording time of T_{bef} seconds before the first trigger generation, i.e., T_{bef}+T_{aft} seconds, corresponds to a total time of a recording range for one event. A maximum of 30 seconds can be set in a range from 5 seconds or more but 25 seconds or less before the first trigger generation to 5 seconds or more but 25 seconds or less after the first trigger generation.

Furthermore, as the recording condition, when a Lo signal is outputted which switches the status of the vehicle from the occupied state to the vacant state, speech information and vehicle's occupied/vacant status information of the information that is recorded in the secondary SD-RAM 30 are recorded in the CF card 11 for a maximum recording range of 30 seconds based on a point in time TR4 when the Lo signal is outputted (referred to as a second trigger generation point). A time Rh resulting when a recording time of T_{aft} seconds after the second trigger generation is added to a recording time of T_{bef} seconds before the second trigger generation, i.e., T_{bef}+T_{aft} seconds, corresponds to a total time of a recording range for one event. A maximum of 30 seconds can be set in a range from 5 seconds or more but 25 seconds or less before the second trigger generation to 5 seconds or more but 25 seconds or less after the second trigger generation.

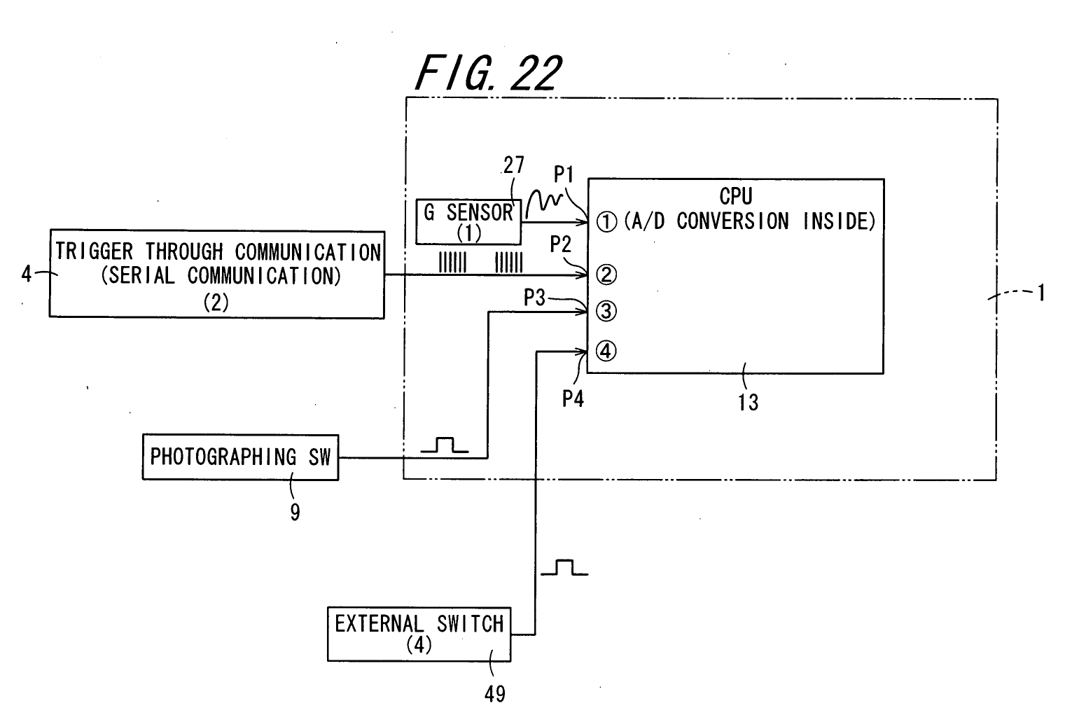

FIG. 22 is a block diagram which describes various ways of taking in triggers in the drive recorder 1. In this embodiment, vehicle's occupied/vacant status information is not inputted directly by means of a switch or the like which is attached to the drive recorder 1 but is acquired from the control unit 2 through serial communication so as to record it as a trigger. Consequently, the trigger input can be executed by the G sensor 27, communication (the center 4, vehicle's occupied/vacant status), photographing switch and external switch 49.

Information from the control unit 2 is transmitted periodically and is monitored periodically on the time axis. However, in communication, a trigger is taken in as an interruption. Namely, a trigger from the center 4 and a trigger for vehicle's occupied/vacant status are taken in as an interruption. Since ON/OFF signals of the other switches can be inputted as an input by the external switch 49, an ON/OFF signal of a vehicle's occupied/vacant status switch may be adopted as an input by the relevant external switch, or an ON/OFF signal of the photographing switch (forced switching by the driver) may be adopted as an input by the relevant external switch. The external switch input can detect both trigger and state. For example, in the case of vehicle's occupied/vacant status, a change in vehicle's occupied/vacant status can be inputted as a trigger, and the occupied or vacant state can also be taken in to be recorded.

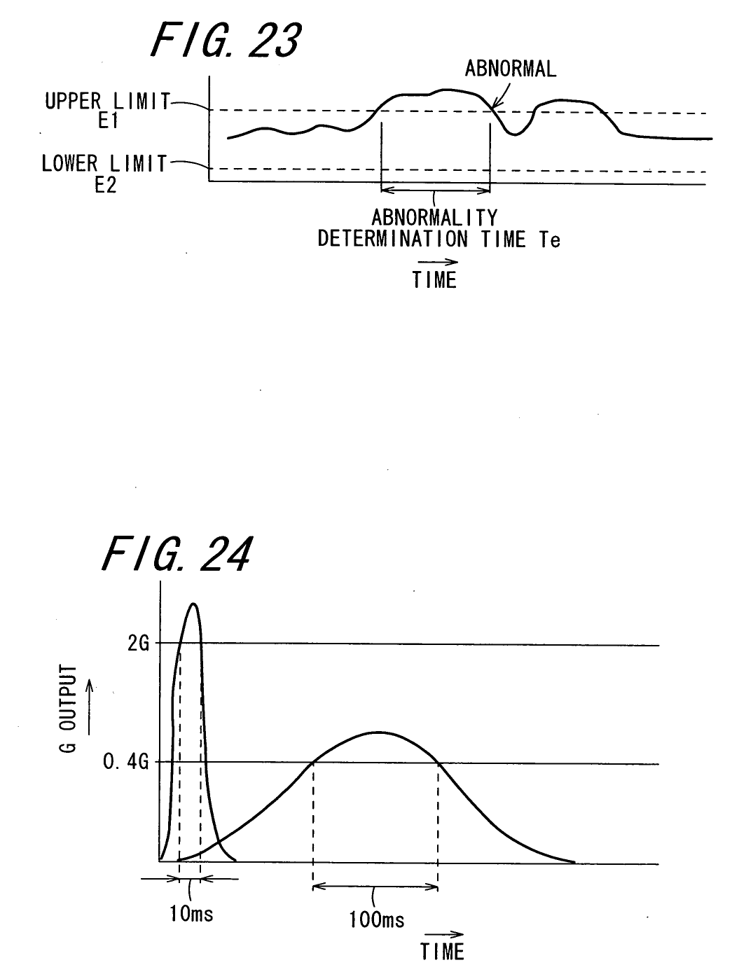

FIG. 23 is a graph showing how warning information is sent out based on a threshold value of the operation data. When the primary CPU 13 detects an abnormal driving of the vehicle 3 based on at least any of the operation data such as speed, periodic recording, sudden acceleration, sudden braking and abrupt steering of the vehicle 3, warning information is given to the driver by means of the buzzer 8. The warning continues to be given every 30 seconds in the event that the abnormal driving continues after the warning information has been given to the driver. However, the primary CPU 13 prohibits the warning by the buzzer 8 while a vehicle dispatch instruction is being given to the vehicle from the center 4. A determination standard to determine whether or not an abnormal driving is occurring is designated in advance by the CF card 11. As shown in FIG. 23, an upper limit E1 and a lower limit E2 of an abnormality detection threshold value and an abnormality determination time Te are regulated as parameters. When the upper limit continues to be exceeded over an “abnormality determination time” that is determined in advance or more, the driving causing such a state is then determined as abnormal driving. While in this embodiment, the warning information is given by the buzzer 8, the invention is not limited thereto. A speaker SP (refer to FIG. 7) is provided in the control unit 2 or the drive recorder 1, so that a speech synthesis (such as a speech synthesis warning, “Reduce the speed. The regulated speed is being exceeded.”) can be outputted.

A case will be described where an abnormal driving is detected based on sudden acceleration or sudden braking. The primary CPU 13 acquires the speed of the vehicle 3 or the vehicle speed every 0.1 second, for example, by means of vehicle speed pulse and determines on an abnormal driving by acceleration for one second. The primary CPU 13 gives the taxi driver waning information by means of the buzzer 8 when the acceleration exceeds a determination value and records the acceleration on the CF card 11. In the event that the acceleration reaches or exceeds a designated acceleration, the primary CPU 13 determines the acceleration as a “sudden acceleration”, whereas in the event that deceleration reaches or lowers below a designated deceleration, the primary CPU 13 determines the deceleration as a “sudden braking.” Acceleration and deceleration which constitute determination standards can be set in two ways for occupied and vacant states.

A case will be described where an abnormal driving is detected by excess speed. The primary CPU 13 acquires the vehicle speed every 0.1 second, for example, by means of vehicle speed pulse and gives the taxi driver warning information in the event that the vehicle speed exceeds a regulated excess speed determination speed and a regulated warning start time has elapsed by means of the buzzer 8. The primary CPU 13 gives the warning information by means of the buzzer 8 in the event that the vehicle speed exceeds the regulated excess speed determination speed and the abnormality determination time Te has elapsed and records the speed of the vehicle 3 on the CF card 11. The primary CPU 13 is designed to release the excess speed determination when while the vehicle speed is reduced to the excess speed determination speed or lower, road segments of normal road and highway are changed from one to the other. Determination speed and warning start time can be set in two ways for the road segments.

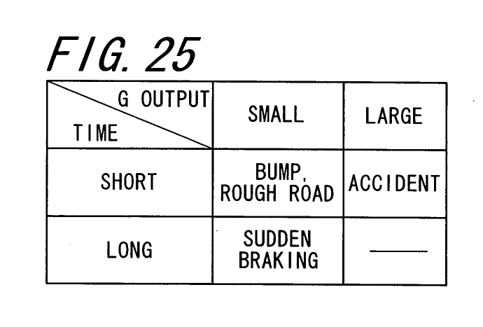

FIG. 24 is a graph showing a relationship between G sensor output value and detection time. FIG. 25 is a chart showing tendencies based on a relationship between the magnitude of G sensor output value and detection time thereof. When a necessary and sufficient capacity is not left in the recording capacity of the CF card 11 and the G sensor output value that has already been recorded in the CF card 11 is smaller than a G sensor output value that is detected additionally, the primary CPU 13 executes a control such that the G sensor output value that has already been recorded is deleted and the G sensor output value that is detected is recorded in the CF card 11. With a free capacity of the recording capacity of the CF card 11 being sufficient for necessity, even in the event that the G sensor output value that has already been recorded in the CF card 11 is smaller than the G sensor output value that is detected additionally, the G sensor output value that is detected additionally on the CF card 11 is designed to be recorded without deleting the G sensor output value that has already been recorded.

In the event that the G sensor output value is small (for example, 0.4 G or greater but less than 2 G) and a detection time thereof is short (for example, several tens of milliseconds), it means that the vehicle 3 is passing on a bump on a road or being driven on a rough road. In the event that the G sensor output value is small and the detection time thereof is long (for example, 100 milliseconds or longer), it means that a sudden braking is applied to the vehicle 3. In addition, in the event that the G sensor output value is large (for example, 2 G or larger) and the detection time thereof is short, it means that the vehicle is involved in an accident. The applicant of this patent application stores data on tendencies based a relationship between the magnitude of the G sensor output value and detection time thereof in the memory of the center equipment through experiments or the like.

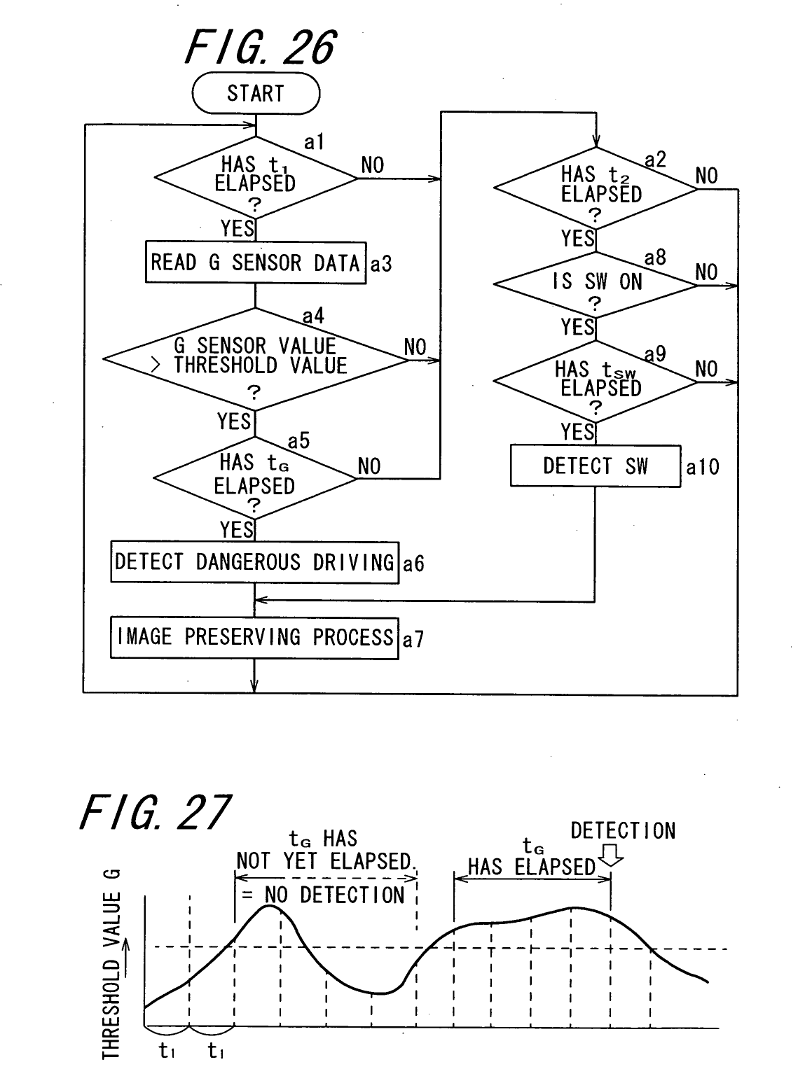

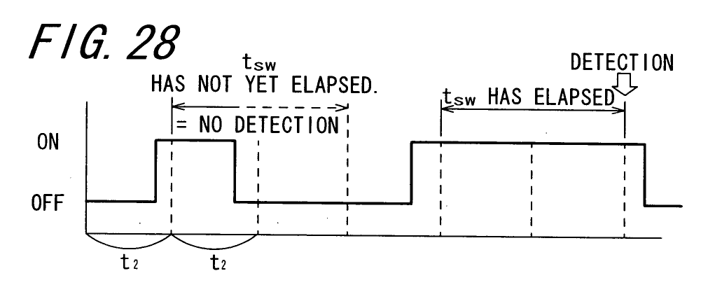

FIG. 26 is a flowchart illustrating a basic operation by the G sensor and external switch detection. FIG. 27 is a graph showing a relationship between a threshold value of the G sensor output value and determination time thereof. FIG. 28 is a timing chart showing a relationship between Hi/Lo signals and determination time thereof. This flow is started on condition that an ACC signal supplied from the accessory power supply is on and the power supply of the control switch 2 is switched on. In Step a1 after the flow has been started, the primary CPU 13 determines whether or not a periodic sensing timing t1 (t1 is, for example, 10 milliseconds) of the G sensor 27 has elapsed (refer to FIG. 27). If the primary CPU 13 determines “false,” the flow proceeds to Step a2. If the primary CPU 13 determines that t1 has elapsed, the flow proceeds to Step a3, where the primary CPU 13 has a G sensor output value recorded in the secondary SD-RAM 30, and in Step a4, the primary CPU 13 determines whether or not the G sensor output value is larger than a threshold value. If the primary CPU 13 determines “false,” the flow proceeds to Step a2.

If the primary CPU 13 determines that the G sensor output value is larger than the threshold value, the flow proceeds to Step a5, where the primary CPU 13 determines whether or not a threshold value determination time Tg that is determined originally has elapsed. The threshold value determination time Tg is set larger than the sensing timing t1. The threshold value determination time Tg is started to be counted from a point in time when the G sensor output value exceeds the threshold value, and when a continuous time during which the G sensor output value exceeds the threshold value reaches the time Tg, the primary CPU 13 determines that the threshold value determination time Tg has elapsed. If the primary CPU 13 determines that the threshold value determination time Tg has not yet elapsed, the flow proceeds to Step a2. On the contrary, if the primary CPU 13 determines that the threshold value determination time Tg has elapsed, the flow proceeds to Step a6. Here, the primary CPU 13 detects that the vehicle 3 is being driven in a dangerous fashion. Next, the flow proceeds to Step a7, where the primary CPU 13 has image information recorded in the secondary SD-RAM 30 recorded in the CF card 11. Thereafter, the flow returns to Step a1. A malfunction due to noise can be prevented by providing the threshold value determination time Tg like this.

In Step a2, the primary CPU 13 determines whether or not a periodic sensing timing t2 (t2 is, for example, 100 milliseconds) has elapsed (refer to FIG. 28). If the primary CPU 13 determines “false,” the flow returns to Step a1. If the CPU 13 determines that t2 has elapsed, the flow proceeds to Step 8, where the primary CPU 13 determines whether or not the external switch 49 has been switched on, and if the primary CPU 13 determines “false,” the flow returns to Step a1. On the contrary, if the primary CPU 13 determines that the external switch 49 has been switched on, the flow proceeds to Step a9, where the primary CPU 13 determines whether or not a signal determination time Tsw that is determined originally has elapsed. This signal determination time Tsw is set to be larger than the sensing timing t2. The signal determination time Tsw is started to be counted from a point in time when the external switch 49 has been switched from ON to OFF, and a continuous time during which the external switch 49 continues to be on reaches the signal determination time Tsw, the primary CPU 13 determines that the signal determination time Tsw has elapsed. If the primary CPU 13 determines that the signal determination time Tsw has not yet elapsed, the flow returns to Step a1. On the contrary, if the primary CPU 13 determines that the signal determination time Tsw has elapsed, the flow proceeds to Step a10, where the primary CPU 13 detects the external switch 49, thereafter, the flow proceeding to Step a7. A malfunction due to noise can be provided by providing the signal determination time Tsw.

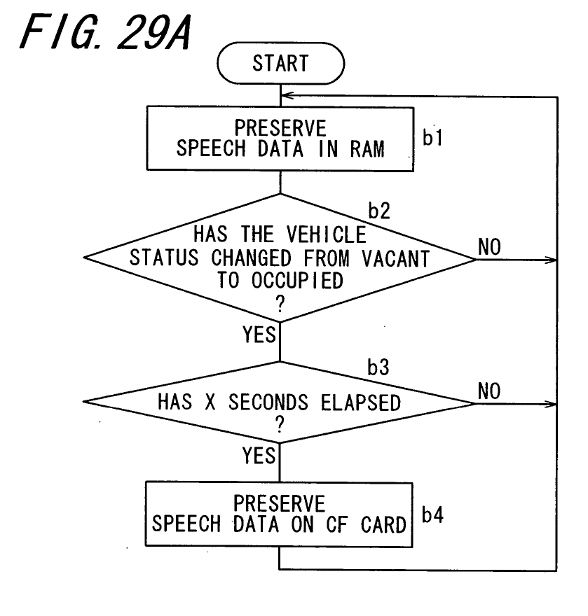

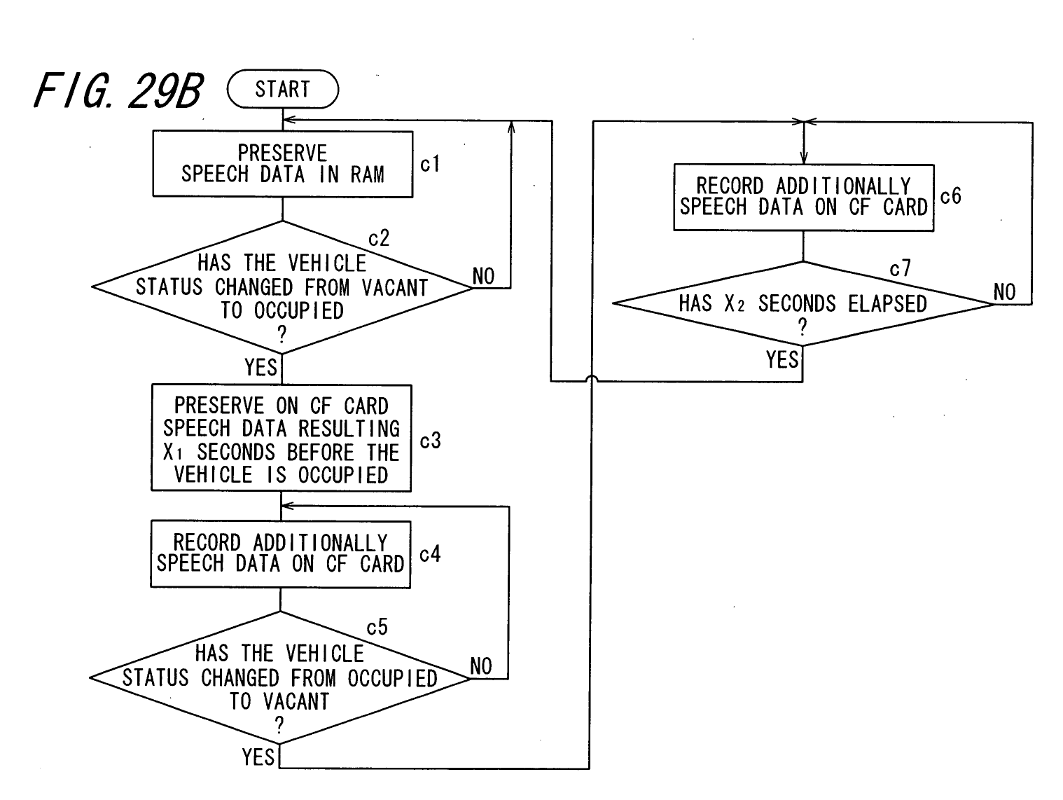

FIGS. 29A and 29B are flowcharts illustrating processes for recording speed data, in which FIG. 29A is a flowchart illustrating a process for recording speech data from before to after a change in vehicle's occupied/vacant status, and FIG. 29B is a flowchart illustrating a process for recording speech data while the vehicle is being occupied. This flow is started on condition that an ACC signal supplied from the accessory power supply is on or the power supply for the control unit 2 is switched on. As shown in FIG. 29A, in Step b1 after the flow has been started, the primary CPU 13 has speech data (meaning speech information) recorded in the secondary SD-RAM 30 endlessly. Next, the flow proceeds to Step b2, where the primary CPU 13 detects whether the vehicle's occupied/vacant status switch is on or off based on a signal from the control unit 2. Namely, since the control unit 2 sends out only a signal indicating whether the vehicle is in the occupied state or vacant state, a change from a vacant state into an occupied state is detected on the drive recorder 1 side.

Since the vehicle status is monitored by the drive recorder 1, if a vacant state is detected at a certain timing, the status so detected is recorded, and if an occupied state is detected at the following timing, the drive recorder 1 can detect that the vehicle's occupied/vacant status has changed from “the vacant state to the occupied state” from a comparison of the “vacant state” information that is stored to the “occupied state” information that is detected this time. In this way, the drive recorder 1 is designed to detect indirectly whether the vehicle's occupied/vacant status switch is on or off.

If the primary CPU 13 determines “false” in Step b2, the flow returns to Step b1. If the primary CPU 13 determines that the change has occurred, the flow proceeds to Step b3, where the primary CPU 13 determines whether or not an elapsing time is x seconds (x seconds are, for example, 30 seconds) between before and after changing of the switching mode of the vehicle's occupied/vacant status switch 44, the elapsing time including a vacant state time (T_{bef} seconds) which results before a point in time when the vehicle's occupied state is determined and a time (T_{aft} seconds) which results after the vehicle is occupied. If the primary CPU 13 determines “false,” the flow returns to Step b1. Determining that the relevant time has elapsed, the primary CPU 13 has speech data recorded in the CF card 11. The speech data has been stored in the secondary SD-RAM 30 over x seconds (that is, the time Rh indicated in FIG. 21) between before and after the change has occurred. Thereafter, the flow returns to Step b1.

There may occur a case where a process is executed in which speech data while the vehicle is being occupied is recorded in the CF card 11. As shown in FIG. 29B, the flow proceeds to Step c1 on the same starting condition as the flowchart that has been described above, so that speech information is recorded in the secondary SD-RAM 30 endlessly. Next, in Step c2, the primary CPU 13 detects whether the vehicle's occupied/vacant status switch is on or off based on a signal from the control unit 2. Namely, since the control unit 2 sends out only a signal indicating whether the vehicle is in the occupied state or vacant state, a change from the vacant state into the occupied state is detected on the drive recorder 1 side as done in Step b2.

If the primary CPU 13 determines “false” in Step c2, the flow returns to Step c1. If the primary CPU 13 determines that the vehicle's occupied/vacant status has changed from the vacant state to the occupied state, the flow proceeds to Step c3. Here, the primary CPU 13 the speech data that has been recorded in the secondary SD-RAM 30 endlessly recorded in the CF card 11 from x1 seconds (T_{bef} seconds in FIG. 20) before a point in time when a signal is outputted which switches the status of the vehicle from a vacant state to an occupied state. Next, in Step C4, the primary CPU 13 has speech data which results after the vehicle status has been determined as occupied on the CF card 11 continuously. Next, in Step c5, the primary CPU 13 determines whether or not the vehicle's occupied/vacant status has changed from the occupied state to the vacant state. If the primary CPU 13 determines “false,” the flow returns to Step c4. On the contrary, if the primary CPU 13 determines that there has occurred in a change in the occupied/vacant status of the vehicle in Step c5, the flow proceeds to Step c6, whereby the primary CPU 13 has speech data which results after the status of the vehicle is determined as vacant recorded in the CF card 11 additionally. Thereafter, the flow proceeds to Step c7, where the primary CPU 13 determines whether or not x2 seconds (T_{aft} seconds in FIG. 20) has elapsed since a point in time where a signal is outputted which switches the status of the vehicle from the occupied state to the vacant state. If the primary CPU 13 determines “false,” the flow returns to Step c6. On the contrary, if the primary CPU 13 determines that x2 seconds has elapsed, the flow returns to Step c1.

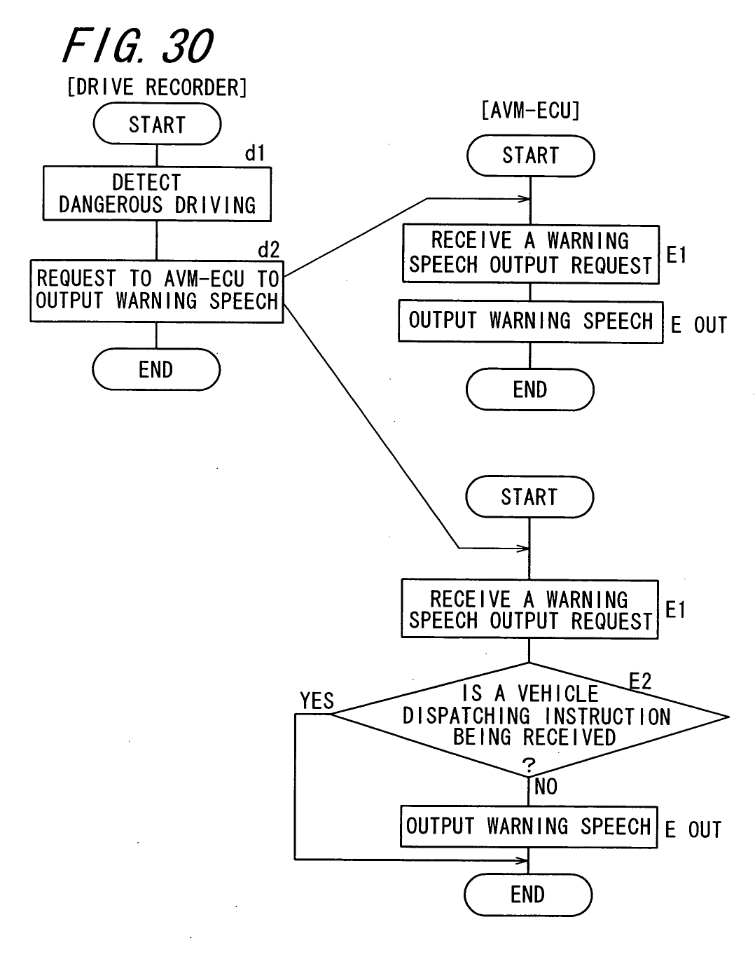

FIG. 30 is a flowchart illustrating a first process for outputting a synthetic speech by the AVM-ECU. This flow is stated on condition that an ACC signal supplied from the accessory power supply is on and the power supply for the control unit 2 is switched on. In Step d1 after the flow has been started, the primary CPU 13 detects a dangerous driving of the vehicle 3, the flow proceeds to Step d2, where the primary CPU 13 request the secondary CPU 31 of the control unit 2 to output a warning speech.

In Step E1, when the secondary CPU 31 receives the warning speech output request on the control unit 2 side, in Step Eout, the secondary CPU 31 makes the speaker SP (refer to FIG. 7) output a speech synthesis (such as a speech synthesis warning, “Reduce the speed. The regulated speed is being exceeded.”). When the vehicle 3 is receiving a dispatch instruction from the center 4 (Step E2: YES), the secondary CPU 31 ends this process without making the speaker SP output the speech. In the event that the vehicle is not receiving a dispatch instruction, the speaker SP is made to output the speech synthesis in Step Eout.

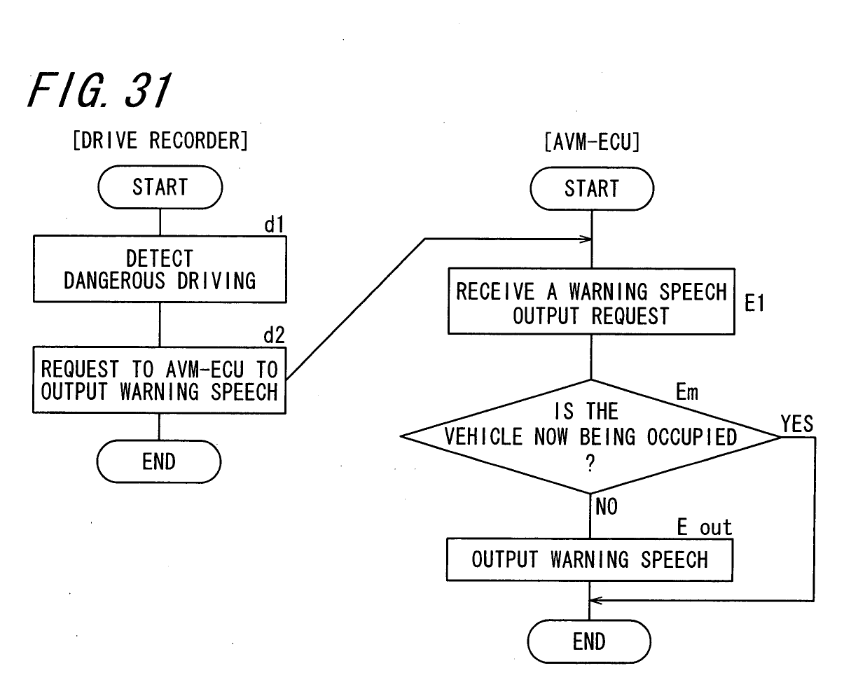

FIG. 31 is a flowchart illustrating a second process for outputting a synthetic speech by the AVM-ECU. In Step E1, when the secondary CPU 31 receives the warning speech output request on the control unit 2 side, the flow proceeds to Step Em, where the secondary CPU 31 determines from the vehicle's occupied/vacant status indicating meter 44 whether or not the vehicle is currently occupied. If the secondary CPU 31 determines “false,” the flow proceeds to Step Eout, where the secondary CPU 31 makes the speaker SP output a speech synthesis. Determining that the vehicle is being occupied in Step Em, the secondary CPU 31 ends this process without making the speaker SP output the speech.

According to the drive recorder 1 of the embodiment that has been described heretofore, a plurality of pieces of information (image, G value, position, time, occupied/vacant status, vehicle speed, speech and the like) are recorded in the secondary SD-RAM 30 endlessly. In the case of other triggers (G sensor and the like) than vehicle's occupied/vacant status, image, G value, position, time, occupied/vacant status, vehicle speed, and speech are recorded in the card. In the case of a trigger for vehicle's occupied/vacant status, among the triggers, only speech and vehicle's occupied/vacant status are recorded in the CF card 11. Namely, in the vehicle's occupied/vacant status mode, in order to monitor the driver's hospitality to the customer, driving information required is sufficient in case only the speech of the driver and the occupied/vacant status of the vehicle are given, and hence, image, vehicle speed and the like become unnecessary. This is because the driver's hospitality to the customer which is exhibited when the vehicle status is changed to the occupied state can be understood from the speech of the driver. Consequently, as much free capacity as possible can be secured on the CF card 11. Even in taking in the plurality of triggers on to the CF card 11 in this way, the optimum driving information for the occupied/vacant status of the vehicle can be taken in so as to avoid the waste of recording capacity.

In the event that the camera is directed towards the inside of the vehicle or directed towards the driver, a resulting image is also recorded in the CF card 11. Namely, in taking in the plurality of triggers to record the plurality of pieces of driving information, appropriate driving information according to the contents of the triggers can be recorded. In the vehicle's occupied/vacant status mode, recording does not necessarily have to be carried out both for the occupied state and the vacant state, and hence, recording may only have to be carried out either for the occupied state or for the vacant state. Only the hospitality exhibited to the customer by the driver may be recorded when the vehicle status is changed from the vacant state to the occupied state. In this case, the free capacity of the CF card 11 can be secured further, so as to avoid the waste of recording capacity of the card. Since information on the hospitality exhibited to the customer by the driver when the passenger or customer gets in and out of the taxi can be recorded in an ensured fashion, the driving guidance for the driver can be carried out effectively.

According to the drive recorder 1, while the speech inside the passenger compartment of the vehicle 3 is recorded while the vehicle is occupied, since not only speech data resulting x1 seconds before the vehicle is occupied is recorded in the CF card 11 but also speech data resulting x2 seconds after the vehicle becomes vacant is recorded in the CF card 11, the following advantages can be provided. The manager for controlling the operation of taxies can instruct the taxi driver to treat his or her customer in such a way to fulfill the customers' satisfaction with a regulated attitude from before a point in time when the taxi driver switches the vehicle's occupied/vacant status indicating meter 44 to indicate the occupied state. The manager can instruct the taxi driver to continue to give the similar service even after the vehicle's occupied/vacant status indicating meter 44 is switched to indicate the vacant state.

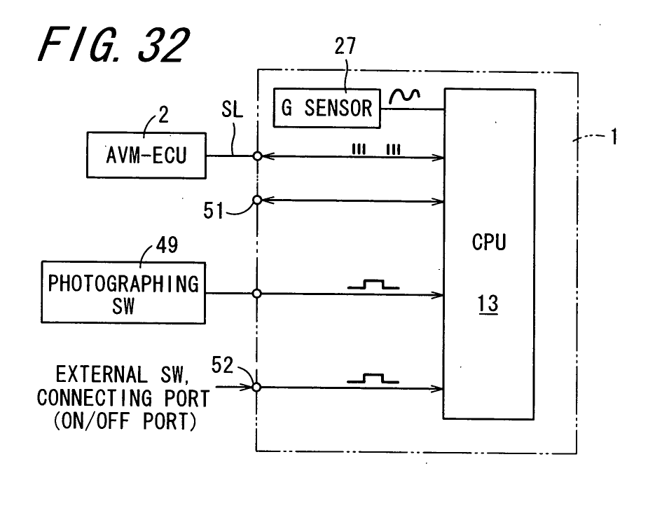

FIG. 32 is a block diagram showing an electrical configuration of the drive recorder 1 in which a serial port 51 of other equipment and other components are incorporated. In the drive recorder 1, the G sensor 27, an instruction from the center 4 or vehicle's occupied/vacant status information from the control unit 2, and the photographing switch 49 are used as triggers. However, a serial (communication) port 51 and an ON/OFF port 52 as an input unit are provided as free ports which can be connected to other equipment so that even other triggers can be realized as triggers to be recorded in the CF card 11. The external switch is made to be connected to not only other switches but also an ECU which outputs an ON/OFF signal.

When detecting an accident by the G sensor 27, in order to detect quickly without any delay, a cycle to monitor triggers is set to 10 milliseconds, for example. The priority of the control unit 2 and the serial port 51 is lower than interruption, and the priority of the photographing switch 49 and the external switch input port 52 is lower than the G sensor 27, a cycle to monitor those triggers is set to 100 milliseconds, for example. For example, in the event that a vehicle's occupied/vacant status switch is inputted as an external switch input, a cycle to monitor a trigger is set to 100 milliseconds, for example.

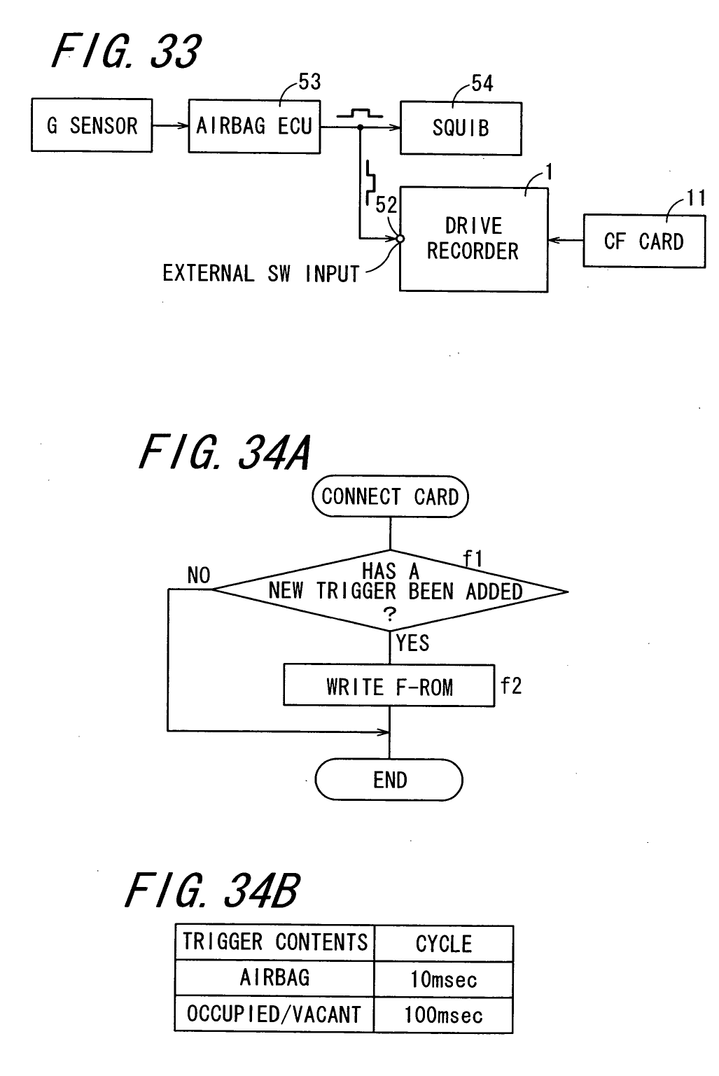

FIG. 33 is a block diagram showing a connection example with an airbag ECU 53. The airbag ECU 53, which is a vehicle state detecting unit, outputs an ON signal to ignite a squib 54 functioning as an igniter based on a G value from the G sensor in the event that there occurs an impact of a certain magnitude or greater. The drive recorder 1 is configured so as to take in this ON signal as an external switch input. In the case of the airbag ECU 53, it is necessary to detect a trigger without delay in order to detect a collision and therefore, in the event that the airbag ECU 53 is connected to the drive recorder 1, the cycle to monitor triggers is changed from 100 milliseconds to 10 milliseconds. In changing the trigger monitoring cycle, a version-up is carried out using the CF card 11. Namely, a corresponding port number, trigger cycle and the contents of the trigger are recorded in the CF card 11, and the drive recorder installs each of them for change.

FIGS. 34A and 34B show a process for changing the trigger monitoring cycle or the like, in which FIG. 34A is a flowchart, and FIG. 34B is a map showing trigger cycles corresponding to various triggers. This flow starts on condition that an ACC signal supplied from the accessory power supply becomes on. After the start of the flow, the flow proceeds to Step f1, where the primary CPU 13 determines whether or not a new trigger has been added. If the primary CPU 13 determines “false,” the process ends. If the primary CPU 13 determines that the new trigger has been added, the flow proceeds to Step f2, where the primary CPU 13 writes the port number, trigger cycle (a change from 100 milliseconds to 10 milliseconds) and the contents (airbag activation or the like) of the trigger which are recorded in the CF card 11 in a primary ROM (flash ROM) 14. Thereafter, the process ends. However, in place of the flowchart shown in FIG. 34A, it is also possible to preserve trigger cycles corresponding to various triggers in the primary ROM 14 of the drive recorder 1 as a map, as shown in FIG. 34B.

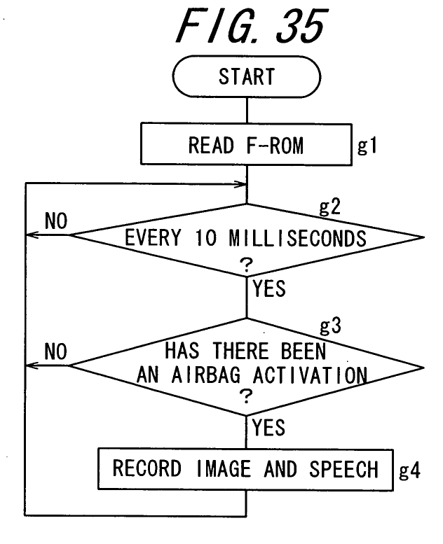

FIG. 35 is a flowchart illustrating a process for recording on the CF card 11 image and speech which result when an airbag is activated. This flow starts on condition that an ACC signal supplied from the accessory power supply is on. In Step g1 after the start of the flow, the primary CPU 13 reads a program or the like of the primary ROM 14, and the flow proceeds to Step g2. In reality, the primary CPU 13 operates according to the program. Here, the primary CPU 13 determines whether or not the trigger monitoring cycle is 10 milliseconds or a monitoring timing has resulted. If the primary CPU 13 determines “false,” the flow returns to Step g2. If the primary CPU 13 determines that the monitoring is now set to occur every 10 milliseconds, the flow proceeds to Step g3, where the primary CPU 13 determines whether or not an airbag activation has occurred. If the primary CPU 13 determines “false,” the flow returns to Step g2. On the contrary, if the primary CPU 13 determines “true,” the flow proceeds to Step g4, where the primary CPU 13 has image and speech recorded in the CF card 11. Thereafter, the flow returns to Step g2. In addition, although not shown, the other triggers including the G sensor 27 and the like are also monitored at predetermined trigger monitoring cycles.

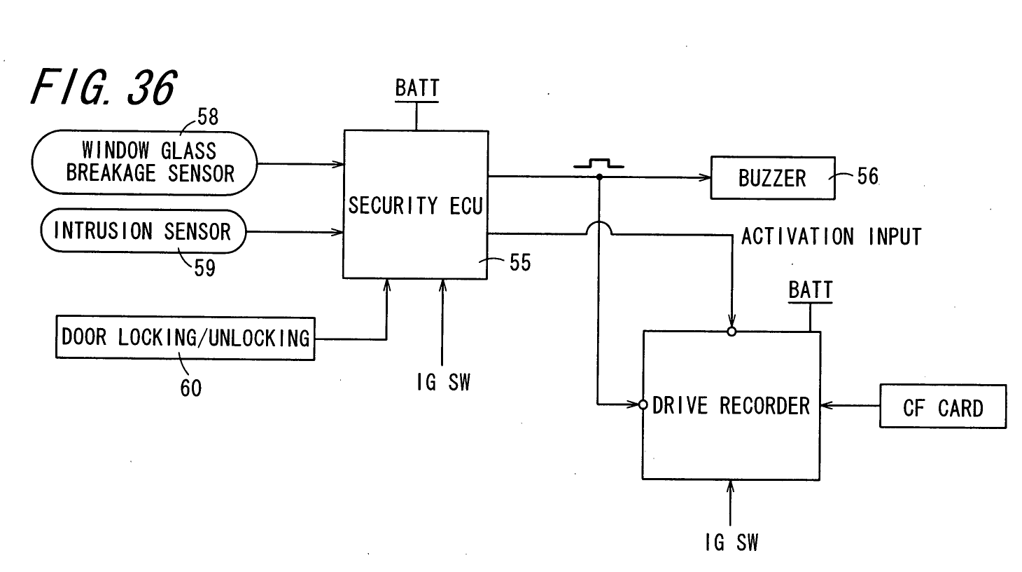

FIG. 36 is a block diagram showing a connection example (1) with a security ECU 55. In the case of security, with a door lock and IG being off, a monitoring mode is brought on. It is determined by a door locked/unlocked state detecting switch 60 whether or not the door is locked. The security ECU 55 outputs an ON signal to activate a buzzer 56 when a window glass breakage or an intrusion into the vehicle is detected by the sensors 58, 59 in the monitoring mode. The drive recorder 1 according to this embodiment is designed to record images (images inside and outside the vehicle) and speech on the CF card 11 when the security is activated to be in operation when it takes in the ON signal as an external input. In the security, since the monitoring mode results when the IG is off, an activation signal is made to be outputted from the security ECU 55 to the drive recorder 1 even when IG is off so as to keep the driver recorder 1 activated.

In the case of security, while the trigger monitoring cycle is 100 milliseconds, a port to be monitored when IG is off is for the external input switch only, and the other ports for the G sensor 27, the control unit 2 and the like do not have to be monitored. This is because the vehicle is stationary and the other triggers do not have to be monitored. Consequently, the processing load of the primary CPU 13 can be reduced so as to attempt to reduce power consumption. A method for connecting the security ECU 55 additionally is the same as the method used in the case of the airbag ECU 53, and hence, the description thereof will be omitted herein.

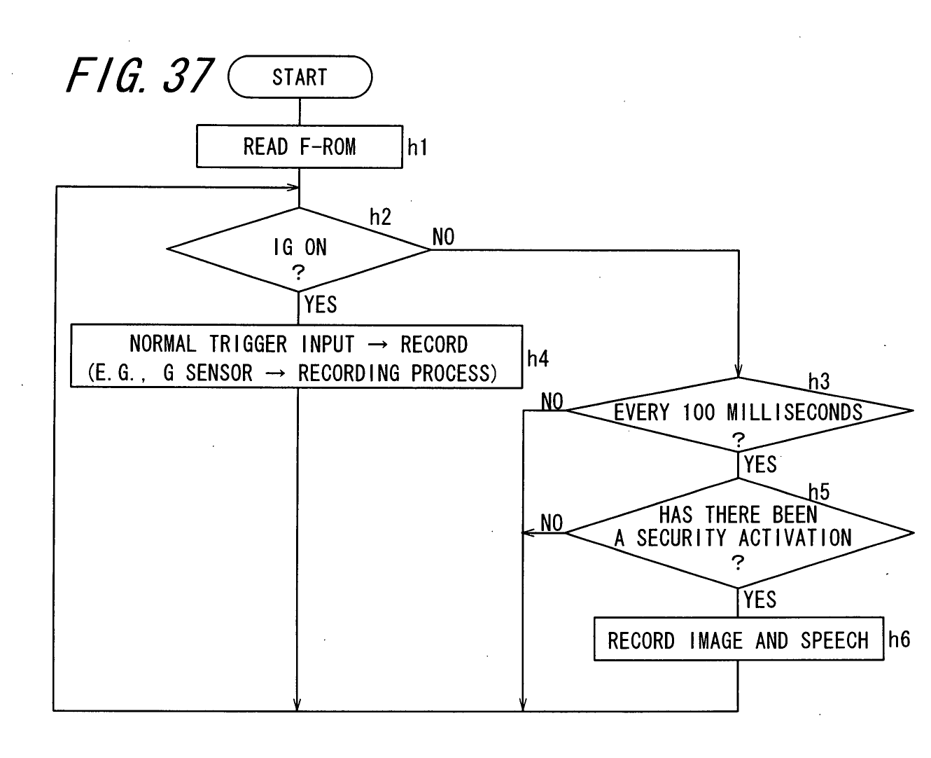

FIG. 37 is a flowchart illustrating a process for monitoring an external input SW only. This process starts on condition that an activation signal is outputted from the security ECU 55 to the drive recorder 1 so as to keep the drive recorder 1 activated (ACC ON). After the start thereof, the flow proceeds to Step h1, where the primary CPU 13 reads the contents of the primary ROM 14, and the flow proceeds to Step h2, where the primary CPU 13 determines whether or not IG is on. If the primary CPU 13 determines “false,” or that IG is off and the driving of the vehicle is stopped, the flow proceeds to Step h3, whereas if the primary CPU 13 determines that IG is on, the flow proceeds to Step h4. In Step h4, the primary CPU 13 executes the process to implement the recording on the CF card 11 when there occurs a normal trigger input.

In Step h3, the primary CPU 13 determines whether or not the trigger monitoring cycle is 100 milliseconds or the monitoring timing has resulted. If the primary CPU 13 determines “false,” the flow returns to Step h2. On the contrary, if the primary CPU 13 determines that the trigger monitoring is now carried out every 100 milliseconds, the flow proceeds to Step h5, where the primary CPU 13 determines whether or not there has occurred a security activation (there exists an alarming signal). If the primary CPU 13 determines “false,” the flow returns to Step h2. On the contrary, if the primary CPU 13 determines that there has occurred the security activation, the flow proceeds to Step h6, where the primary CPU 13 has image and speech recorded in the CF card 11. Thereafter, the flow returns to Step h2. Consequently, when IG is off, the flow does not proceed to Step h4, and the monitoring of the other triggers is ignored.

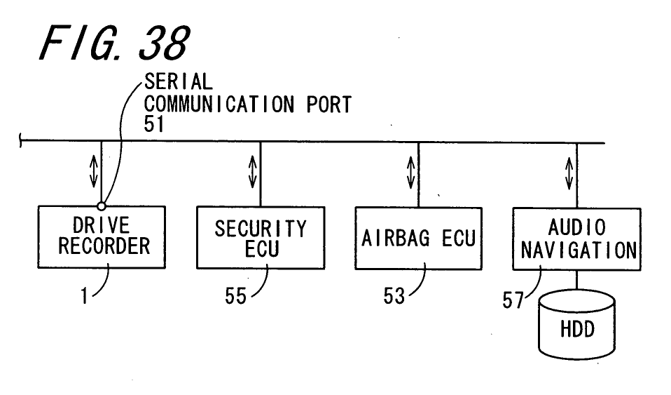

FIG. 38 is a block diagram illustrating a connection example with a plurality of pieces of equipment. Not only the input of the triggers but also the input/output of information can be executed by applying the serial communication port 51 of the drive recorder 1 thereto. For example, in the event that there is a trigger coming from the airbag, the degree of impact is taken in from the airbag ECU 53 and traffic information (traffic jam information) is taken in from a audio/navigation system 57, and the drive recorder 1 has them recorded in the CF card 11, whereby an accident analysis can be carried out in greater detail.

According to the drive recorder 1 that has been described heretofore, a signal from the airbag ECU 53 or security ECU 55 is inputted from the ON/OFF port 52, the primary CPU 13 controls using the signal so inputted as a trigger such that recording is implemented on the CF card 11. In particular, since the ON/OFF port 52 is made to admit the input of a signal from another vehicle state detecting unit which is different from the detecting unit for detecting that the vehicle 3 is put in a predetermined state, the drive recorder 1 does not have to be re-fabricated from the beginning, the costs can be reduced by such an extent. Consequently, the drive recorder having high versatility can be provided in which even in the event that there is made a request for an additional trigger, the requested trigger can be added in a simple fashion.

Since the timing when whether or not there exists a signal indicating the deployment of the airbag is monitored can be set to occur earlier than the predetermined monitoring timing, the monitoring cycle of triggers can be changed appropriately according to the contents of the triggers. Since whether or not there is a signal for raising the alarm when the driving of the vehicle is stopped is monitored while ignoring the other triggers which become unnecessary when the driving of the vehicle is stopped, the contents of the triggers can be limited according to the state of the vehicle. Consequently, the processing load of the primary CPU 13 can be reduced.

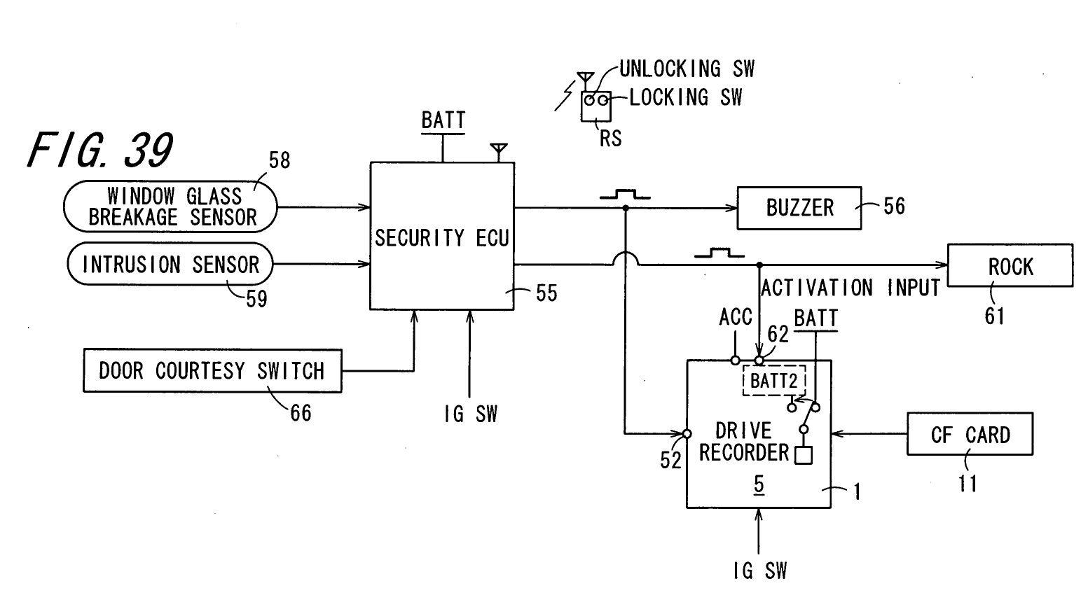

FIG. 39 is a block diagram showing a connection example (2) between the security ECU and the drive recorder according to an embodiment of the invention. Description according to the present embodiment includes also descriptions of a driving information recording method. The following descriptions will be made with reference also to FIG. 8. The security ECU 55 is electrically connected to a window glass breakage sensor 58 for detecting a window glass breakage of the vehicle, an intrusion sensor 59 for detecting an intrusion into the vehicle by means of radio wave or ultrasonic wave, a door courtesy switch 66 for detecting an open or a closed state of door, a vehicle battery (described as “BATT” in the figure), an ignition switch (described as “IG SW” in the figure), and other components. The security ECU 55 receives a signal requesting for locking or unlocking, which is outputted from the RS transmitter, and controls a vehicle door to shift between a locked state and an unlocked (non-locked) state. The security ECU 55 is electrically connected to the buzzer 56 in order to output a signal to activate the buzzer 56, and further connected electrically to a driving source 61 for driving a door lock mechanism (which is to say, locking). The drive recorder 1 is originally provided with a port 62 or the like which serves to take as an external input a so-called lock signal from the security ECU 55 into the driving source 61.

When receiving the signal requesting for locking as well as an ID code (Identification code) from the transmitter RS, the security ECU 55 compares the received ID code with an ID code previously stored in the security ECU 55 itself. When these ID codes correspond to each other, the security ECU 55 outputs the lock signal to the driving source 61 to lock the door, and simultaneously shifts the mode to a theft monitoring mode. In the theft monitoring mode, by means of the glass breakage sensor 58, the intrusion sensor 59, and the door courtesy switch 66, it is determined whether or not there arises an attempt to steal the vehicle. On detecting the attempt to steal the vehicle, the mode is shifted to an alarming mode where the security ECU 55 outputs the alarm signal to activate the buzzer 56.

The drive recorder 1 is configured, for example, so as to be started up by the lock signal. For that purpose, the lock signal is, together with the other inputs (such as ACC), inputted to the OR circuit 47 shown in FIG. 13. That is to say, the configuration is such that the power ON signal and the lock signal according to the embodiment can be supplied respectively to the input side of the OR circuit 47. The primary CPU 13 of the drive recorder 1 is configured so as to monitor whether or not there exists the alarm signal in a state where the drive recorder 1 has been started up by the lock signal. When determining presence of the alarm signal, the primary CPU 13 conducts a control such that the image, speech, etc., which are cyclically stored in the secondary SD-RAM 30 by using the alarm signal as a trigger, is recorded in a rewritable flash ROM, i.e., the primary ROM 14, around the time of trigger generation. The primary ROM 14 corresponds to a storage medium disposed inside of the driving information recording apparatus.

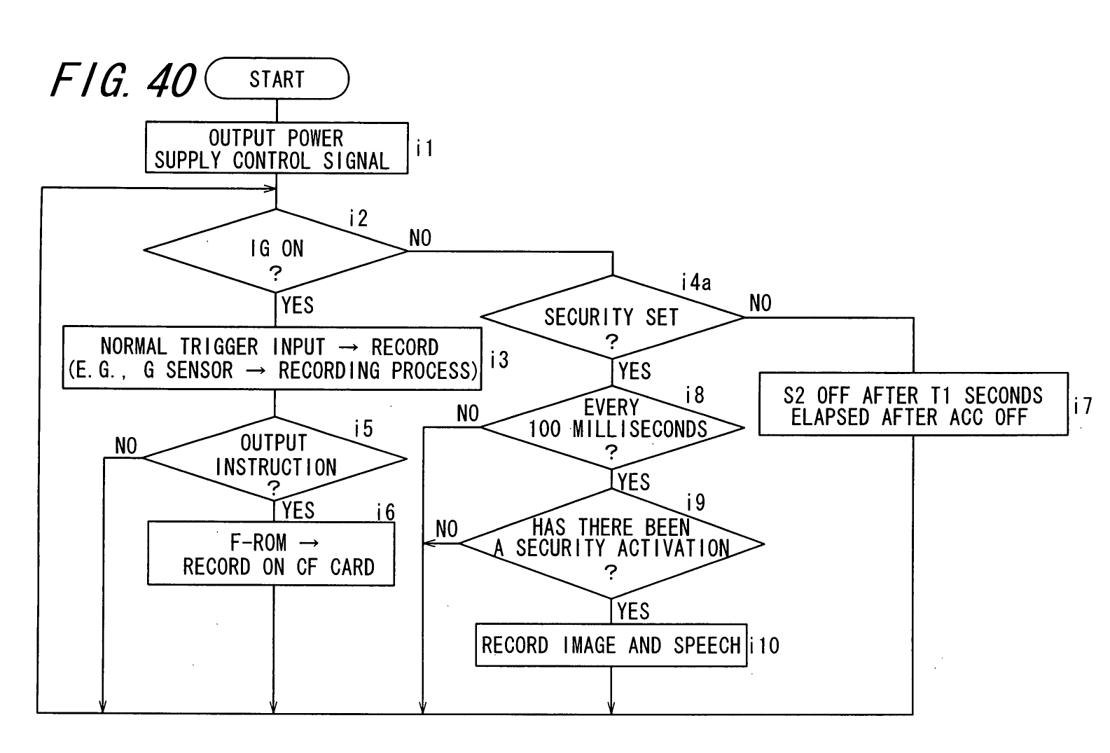

FIG. 40 is a flowchart illustrating a process for recording an image and so forth on the primary ROM 14 based on the lock signal or the like. The present process is started when the drive recorder main body 5 is switched on by ACC, etc. or the lock signal, etc. After the start of the present process, the flow proceeds to Step i1 where the primary CPU 13 outputs the power supply control signal S2 (refer to FIG. 13). The flow then proceeds to Step i2 where the primary CPU 13 determines whether or not the IG is On in order to distinguish whether or not the driver is driving the vehicle.

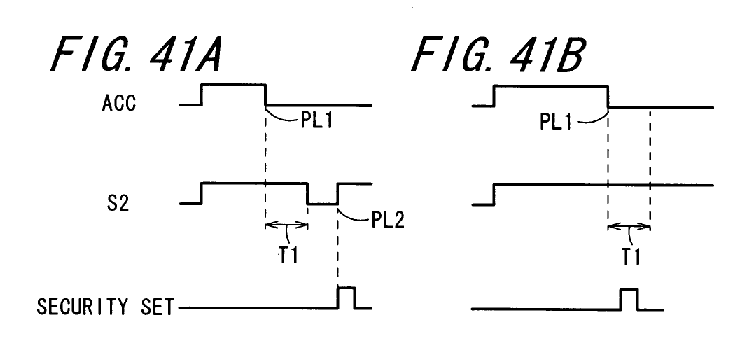

At this point, with a determination such that the IG is ON, or that the driver is driving the vehicle, the flow proceeds to Step i3. With a determination such that the driver is not driving the vehicle, the flow proceeds to Step i4a. At Step i4a, the primary CPU 13 determines whether or not the lock signal is taken in as an external input, in order to distinguish where or not the normal control is conducted as shown in FIG. 12. If the primary CPU 13 determines “false”, the flow proceeds to Step i7. At Step i7, in order that the drive recorder 1 can execute the data recording even in the even that the ACC signal is brought into the OFF state, the primary CPU 13 conducts a control such that the power supply control signal S2 is brought into the OFF state after t1 seconds elapsed after the ACC signal is brought into the OFF state (PL1 in FIGS. 41A and 41B), in other words, the primary CPU 13 executes the normal control shown in FIG. 12. After that, the flow returns to Step i2.

At Step i4a, the primary CPU 13 determines the state as a security set, when the lock signal is taken as an external input from the security ECU 55 into the driving source 61. The flow then proceeds to Step i8. At Step i8, in order to regularly determine presence or absence of the security activation, i.e., the output of alarm signal, the primary CPU 13 determines whether or not the trigger monitoring cycle is, for example, “100 milliseconds”. However, the trigger monitoring cycle is not necessarily limited to 100 milliseconds. If the primary CPU 13 determines “false”, the flow returns to Step i2.

If the primary CPU 13 determines that the trigger monitoring cycle is 100 milliseconds, the flow proceeds to Step i9, where the primary CPU 13 determines the presence or absence of the output of alarm signal, which is to be a trigger for recording image, speech, etc. If the primary CPU 13 determines the presence of the output of alarm signal, that is, the presence of the attempt to steal the vehicle, the flow proceeds to Step i10. At Step i10, the primary CPU 13 executes a process for recording on the primary ROM 14 the driving information including image and speech stored in the secondary SD-RAM 30. Thereafter, the flow returns to Step i2. By recording the driving information not on the CF card 11 but on the primary ROM 14 when there is an attempt to steal the vehicle, it is possible to prevent the recording medium from being taken away by a thief.

With a determination such that the IG is On, or that the driver is driving the vehicle, the primary CPU 13 executes a recording process which is normally executed while the driver is driving vehicle. In other words, with the trigger input, the primary CPU executes a process of recording on the CF card 11 the driving information including image etc., stored in the secondary SD-RAM 30. Next, the flow proceeds to Step i5 where the primary CPU 13 determines presence and absence of output instruction of the driving information recorded in the primary ROM 14. If the primary CPU 13 determines the absence of the output instruction, the flow returns to Step i2. On the contrary, if the primary CPU 13 determines the presence of the output instruction, the flow proceeds to Step i6. At Step i6 is executed a process of recording on the CF card 11 the driving information recorded in the primary ROM 14 at Step i10, that is, a record of security.

FIGS. 41A and 41B show timing charts, in which FIG. 41A is a timing chart illustrating a mode that the primary CPU 13 has determined presence of the lock signal in the OFF state of the power supply control signal S2 after T1 seconds elapsed after the ACC signal is brought into the OFF state (PL1), and FIG. 41B is a timing chart illustrating a mode that the primary CPU 13 has determined presence of the lock signal before T1 seconds elapsed after the ACC signal is brought into the OFF state (PL1).

As shown in FIGS. 41A and 41B, the primary CPU 13 counts time from a point that the ACC signal is brought into the OFF state (PL1). When the ACC signal is in the OFF state, the power supply control signal S2 stays in the ON state. As shown in FIG. 41B, when the primary CPU 13 determines that there exists the lock signal (that is, the security set) before T1 seconds elapsed after the ACC signal is brought into the OFF state (PL1), the power supply signal S2 stays in the ON state. As shown in FIG. 41A, the primary CPU 13 shifts the power supply control signal S2 from the ON state to the OFF state after T1 seconds elapsed after the ACC signal is brought into the OFF state (PL1). Thereafter, the primary CPU 13 brings the power supply control signal S2 into the ON state when there exists the lock signal, that is, in a state of the security set.

In the above-described example of connection between the security ECU 55 and the drive recorder, the drive recorder 1 can be started up by using the lock signal outputted by the security ECU, in other words, the drive recorder 1 can be started up by use of not an exclusive signal but a signal indicating that an original theft monitoring state is brought. As shown at Step i4a in FIG. 40, when taking in as an external input the lock signal from the security ECU 55 into the driving source 61, the primary CPU 13 determines that the security set has been brought (Step i4a: YES). Accordingly, compared to the case of using the exclusive signal, the drive recorder 1 can be provided with simplified wiring connections and the reduced number of components and manufacturing processes (with no modification in the security ECU 55 or other components).

Since the presence or absence of the output of alarm signal is determined at short intervals (for example, every 100 millisecondss) after the security set has been brought (Step i4a: YES), the security level can be enhanced. The record of security recorded in the primary ROM 40 inside the drive recorder at step i10 in FIG. 40, is recorded in the CF card 11 at Step i6, and it is therefore possible to supply the CF card 11 easily and reliably to a center equipment or various mechanisms.

The driving information recorded in the primary ROM 14 can also be copied or moved onto the CF card 11 by operations such as to press the photographing switch 9 for a relatively long time (for example, 4 seconds or more and 15 seconds or less) within a certain period of time (T2 seconds=15 seconds) after the ACC signal is brought from the ON state to the OFF state. The driving information recorded in the CF card 11 can be then analyzed easily and swiftly in the center or the like. That is to say, it is possible to analyze the driving information without detaching the drive recorder 1 from the vehicle, so that the convenience can be enhanced.

The drive recorder has a secondary battery BATT2 (refer to FIG. 39) therein, which is different from the battery provided in the vehicle. The constitution may be made so that the secondary battery BATT2 is used to keep the drive recorder 1 running when the IG is off and the security is activated. Alternatively, the primary CUP 13 may conduct a control of switching the power source of the drive recorder 1 from the battery provided in the vehicle to the secondary battery BATT2 when determining that a voltage value of the battery provided in the vehicle becomes a predetermined level (for example, 10 V or less). With the constitution as described above, the drive recorder 1 can be kept running more reliably.

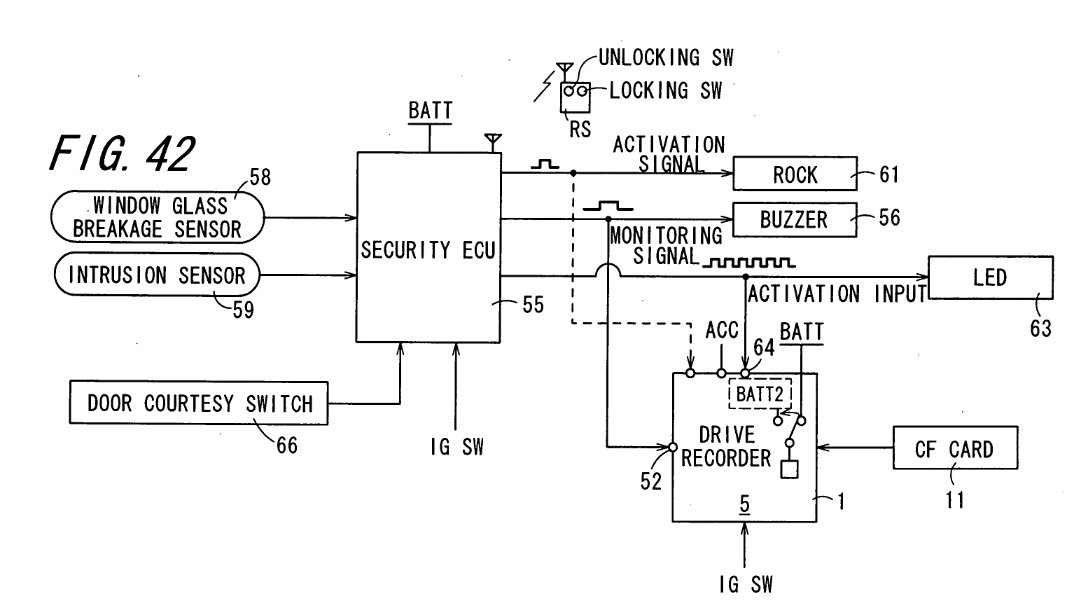

FIG. 42 is a block diagram showing a connection example (3) between the security ECU 55 and the drive recorder 1 according to an embodiment of the invention. In the above-described connection example (2) shown in FIG. 39, the drive recorder takes in as an external input the lock signal outputted from the security ECU 55, while in the connection example (3) according to the present embodiment, the drive recorder 1 takes in as an external input a monitoring signal which is outputted from the security ECU 55 to a light emitting diode 63 (abbreviated as LED) disposed on, for example, a dashboard of the vehicle during the theft monitoring mode.

The drive recorder 1 according to the embodiment is previously provided with a port 64 for taking the monitoring signal as an external input. The drive recorder 1 is configured so as to be started up by the monitoring signal, for example. The primary CPU 13 of the drive recorder 1 is configured so as to monitor whether or not there exists the alarm signal in a state where the drive recorder 1 has been started up by the monitoring signal. Also in the connection example (3) according to the embodiment, compared to the above-described case of using the exclusive signal, the drive recorder 1 can be provided with simplified wiring connections and the reduced number of components and manufacturing processes.

In the above-described connection example (2) shown in FIG. 39, at Step i4a in FIG. 40, the primary CPU 13 determines whether or not the lock signal is taken in as an external input. On the contrary, in the connection example (3) shown in FIG. 42, at Step i4a in FIG. 40, the primary CPU 13 determines whether or not the monitoring signal is taken in as an external input. If the primary CPU 13 determines “false,” the flow proceeds to Step i7 where the monitoring signal is taken in. Next, the flow proceeds to Step i8. Regarding the flowchart of the present connection example (3), the flow proceeds on the same starting condition with the same steps, except Step i4a, as those in the flowchart shown in FIG. 40.

The primary CPU 13 may also determine whether or not either one of the monitoring signal and the lock signal is taken in as an external input. In this case, even if the wiring to the LED 63 is disconnected, the primary CPU 13 can determine, at Step i4a as in the case of the connection example (3), whether or not the lock signal is taken in as an external input. Accordingly, it is possible to further enhance the security level, compared to the case of taking the monitoring signal only as an external input.

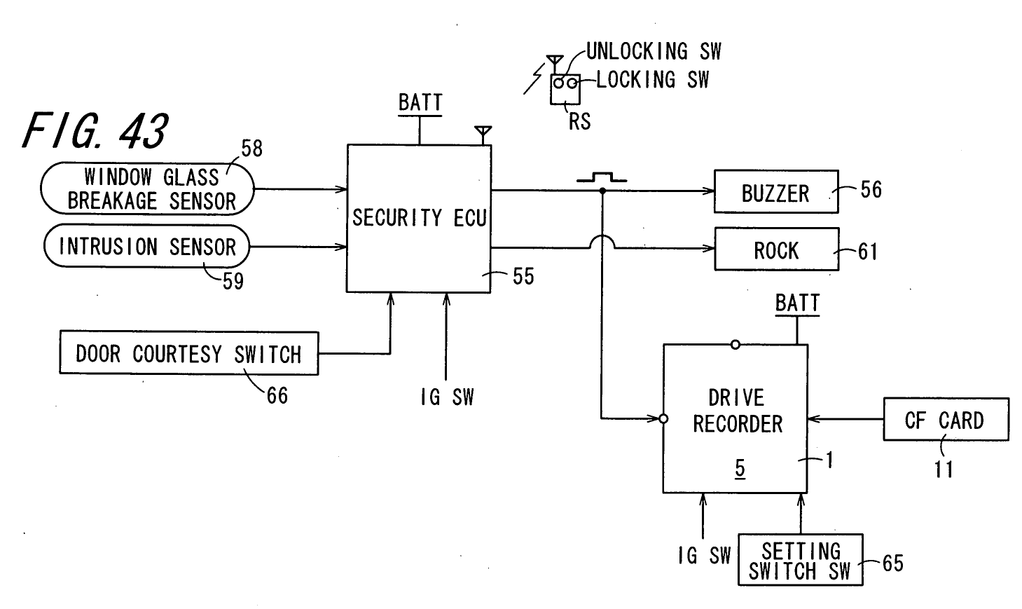

FIG. 43 is a block diagram showing a connection example (4) between the security ECU 55 and the drive recorder according to an embodiment of the invention. The drive recorder 1 of the connection example (4) according to the present invention is provided with a setting switch 65 for setting electrical connection or disconnection of the security ECU 55.

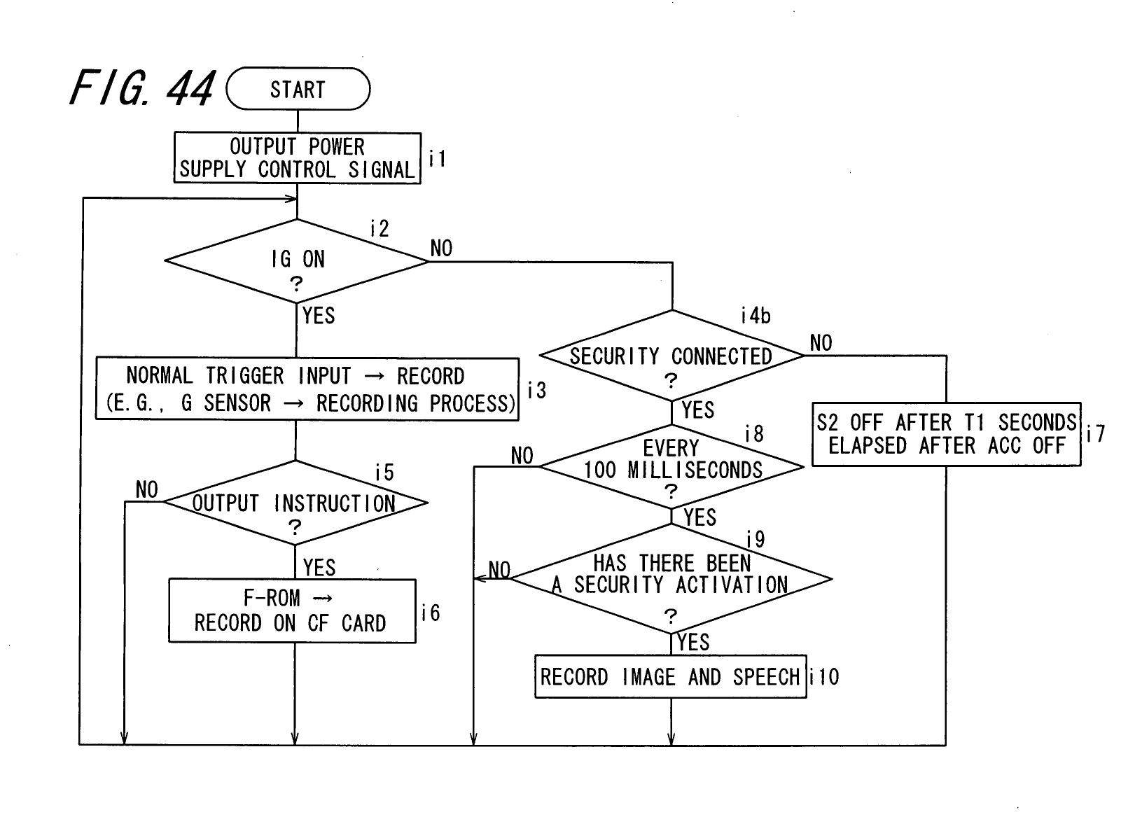

FIG. 44 is a flowchart illustrating a process for recording an image and so forth on the primary ROM 14 based on an operation of a setting switch. The starting condition of the present process is switch-on of the drive recorder main body 5 achieved by the ACC signal or the like. In the present flowchart, steps corresponding to those in the flowchart described with reference to FIG. 40 are denoted by the same step numbers, and description of such steps will be omitted. With a determination obtained at Step i2 that the driver is not driving the vehicle, the flow proceeds to Step i4b where the primary CPU 13 determines whether or not the security ECU 55 is electrically connected thereto based on an operation of the setting switch 65.

To be specific, at Step i4b, if the primary CPU 13 determines that the security ECU 55 is not electrically connected thereto (Step i4b: NO), the flow proceeds to Step i7 where the primary CPU 13 executes a control so as to bring the power supply control signal S2 into the OFF state after T1 seconds elapsed after the ACC signal is brought into the OFF state, that is to say, executes the normal control shown in FIG. 12. At Step i4b, if the primary PCU 13 determines that the security ECU 55 is electrically connected thereto (Step i4b: YES), the flow proceeds to Step i8.

According to the above-described connection example (4), it is possible to realize a system that the electrical connection with the security ECU 55 can be freely selected with ease. It is thus possible to realize a drive recorder having high versatility. And it is also possible to use the setting switch 65 in combination with the photographing switch 9, for example. In the maintenance mode, for example, the photographing switch 9 may be switched to the setting switch. In this case, it is possible to reduce the number of components and manufacturing processes of the drive recorder. In the drive recorder 1, on the basis of a setting program recorded in the CF card 11, it may be set whether or not the electrical connection with the security ECU 55 is maintained or cancelled. The above setting program may be recorded in the CF card 11 by use of the center equipment. It is also possible to previously record the above setting program, for example, onto the primary ROM 14 of the drive recorder main body 5. Also with such a constitution, it is possible to realize the system that the electrical connection with the security ECU 55 can be freely selected with ease.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A driving information recording apparatus comprising a unit for storing cyclically driving information on the driving of a vehicle in a memory unit and a unit for recording the driving information stored in the memory unit in a recording medium using as a trigger a signal that is inputted thereinto from a detecting unit for detecting that the vehicle is put in a predetermined state, the driving information recording apparatus further comprising:
an input unit which is originally provided and into which a signal from a vehicle state detecting unit that is different from the detecting unit can be inputted; and
a control unit for conducting a control such that the driving information stored in the memory unit is recorded in the recording medium using as a trigger a signal inputted from the input unit.

2. The driving information recording apparatus of claim 1, wherein a signal indicating a deployment of an airbag can be inputted into the input unit from an airbag control unit for having the airbag deployed when the vehicle is involved in a collision.

3. The driving information recording apparatus of claim 2, wherein in the control unit, a timing when to monitor whether or not there exists a signal indicating a deployment of an airbag can be set to occur earlier than a monitoring timing which is set originally.

4. The driving information recording apparatus of claim 1, wherein a signal raising an alarm can be inputted into the input unit from a security control unit for raising the alarm when detecting an attempt to steal the vehicle.

5. The driving information recording apparatus of claim 4, wherein the control unit monitors whether or not there exists a signal raising the alarm when the driving of the vehicle is stopped while ignoring the monitor of other unnecessary triggers when the driving of the vehicle is stopped.

6. The driving information recording apparatus of claim 4, wherein the driving information recording apparatus is constituted so as to be started up by receiving a signal indicating an entry into a theft monitoring state, outputted from the security control unit, and
the control unit monitors whether or not there exists an alarm signal in the driving information recording apparatus running after being started up by the signal, and conducts a control such that the driving information stored in the memory unit is recorded using the alarm signal as a trigger.

7. The driving information recording apparatus of claim 4, wherein in a case where a signal indicating an entry into a theft monitoring state, outputted from the security control unit, is inputted into the driving information recording apparatus within a predetermined length of time after an accessory signal of the vehicle is brought into an OFF state,
the control unit keeps the driving information recording apparatus running, monitors whether or not there exists an alarm signal in the running state, and conducts a control such that the driving information stored in the memory unit is recorded using the alarm signal as a trigger.

8. The driving information recording apparatus of claim 4, wherein the control unit and the security control unit are adapted so as to be installable in an electrically connected state or non-connected state, the control unit having a function of determining whether or not being in the connected state,
wherein the control unit being in the connected state with the security control unit, after an accessory signal of the vehicle is brought into an OFF state, keeps the driving information recording apparatus running, monitors whether or not there exists an alarm signal in the running state, and conducts a control such that the driving information stored in the memory unit is recorded using the alarm signal as a trigger.

9. The driving information recording apparatus of claim 6, further comprising a storage medium therein,
wherein the control unit controls such that the driving information stored in the memory unit using the alarm signal as a trigger is recorded in the storage medium disposed inside of the driving information recording apparatus without being recorded in the recording medium.

10. The driving information recording apparatus of claim 9, wherein the control unit conducts a control such that the driving information stored in the storage medium is recorded in the recording medium by a predetermined operation.

11. The driving information recording apparatus of claim 6, wherein further comprising a secondary battery therein, wherein the driving information recording apparatus is kept running by the secondary battery.
